(19) United States
(12) Patent Application Publication
(10) Pub. No.: US 2014/0242214 A1
(43) Pub. Date: Aug. 28, 2014

(54) ENCAPSULATED SWEETNER COMPOSITION, METHOD FOR THE PREPARATION THEREOF, AND CHEWING GUM COMPRISING SAME

(71) Applicant: International Great Brands LLC, East Hanover, NJ (US)

(72) Inventors: Navroz Boghani, Budd Lake, NJ (US); Petros Gebreselassie, Whitehouse Station, NJ (US); Theodore James Anastasiou, Holmdel, NJ (US); Kiran Vyakaranam, Morristown, NJ (US); Junjie Guan, Tenafly, NJ (US); Tana Hintz, Boonton, NJ (US)

(73) Assignee: Intercontinental Great Brands LLC, East Hanover, NJ (US)

(21) Appl. No.: 14/350,209

(22) PCT Filed: Oct. 9, 2012
(86) PCT No.: PCT/US2012/059328

§ 371 Date: Apr. 7, 2014

Related U.S. Application Data
(60) Provisional application No. 61/545,842, filed on Oct. 11, 2011.

(51) Int. Cl. A23G 4/20; A23L 1/236; A23L 1/222; A23L 1/22

(52) U.S. Cl. CPC A23G 4/20; A23L 1/22016; A23L 1/2363; A23L 1/222
USPC 426/5; 426/96; 426/658; 426/655; 426/548

(57) ABSTRACT

Delayed release in chewing gum of a sweetener, is provided by encapsulating the sweetener in specific amounts of a poly(vinyl acetate), a filler, and a fatty acid salt. When incorporated into a chewing gum, the sweetener encapsulated in poly(vinyl acetate), filler, and fatty acid salt provides a more delayed release of a sweet flavor than a sweetener encapsulated in poly(vinyl acetate) alone.

### BACKGROUND OF THE INVENTION

Chewing gum manufacturers have long endeavored to provide longer lasting flavors in chewing gums. In one approach to prolonging flavor, ingredients including flavors, sweeteners, and food-grade acids (to provide sourness) have been encapsulated with polymers to delay and prolong their release. See, for example, U.S. Pat. Nos. 4,931,293, 5,057,328, 5,064,658, and 5,110,608 to Cherukuri et al. In another approach, a sweetener is encapsulated with a polymer and a texture modifier and/or filler, such as glycerol monostearate, hydrogenated oil, calcium carbonate or talc. See, for example, U.S. Pat. Nos. 7,727,565, 7,879,376, and U.S. Patent Application No. 2010/0104689. In still other approaches, a sweetener and oral care ingredient, such as sodium stearate, are encapsulated in a polymer and a texture modifier such as hydrogenated oil, and/or a filler such as calcium carbonate, dicalcium phosphate, or talc. See, for example, U.S. Patent Application Nos. 2005/0260266, US20100104689 A1, and International Patent No. WO/2010/088519.

Other approaches also include an encapsulated sweetener composition for use in a chewing gum, wherein the sweetener is encapsulated with low to medium molecular weight polymers and a texture modifier. See, for example, U.S. Pat. Nos. 4,981,698, 5,229,148, 5,433,960, 7,244,454. Finally, in one approach, a chewing gum has a sweetener that is encapsulated with a polymer and an inorganic salt that can be calcium carbonate to aid in processing and to provide a hard and brittle encapsulation product. In this approach, a small quantity of magnesium stearate (about 0.50 weight percent of the blend) can be included in the blend as a processing aid. See, for example, U.S. Pat. No. 5,154,939.

However, delaying the release of sweeteners that are prone to thermal degradation when exposed to high temperatures by encapsulating sweeteners in high molecular weight polymers has been particularly difficult. It has further been difficult to provide a stable process by which to encapsulate thermally unstable sweeteners in high molecular weight polymers due the need to expose the sweeteners to high processing temperatures. Accordingly, thermally degradable sweeteners have generally been encapsulated in low to medium molecular weight polymer to reduce the amount of heat the sweetener is exposed to during processing. Finally, counteracting the hardening effect caused by incorporating high molecular weight polymer encapsulates into the chewing gum bolus during mastication has also been difficult to overcome. There is therefore a need for materials and methods capable of delaying and extending the release of sweeteners in chewing gum while proving a more stable manufacturing process and an improved texture of the chewing gum bolus.

### BRIEF DESCRIPTION OF EMBODIMENTS OF THE INVENTION

One embodiment is an encapsulated sweetener composition comprising an encapsulating material comprising a poly(vinyl acetate), about 2 to about 20 weight percent of a fatty acid salt selected from the group consisting of alkali metal fatty acid salts, alkaline earth metal fatty acid salts, and combinations thereof, based on the total weight of the encapsulated sweetener composition, and about 2 to about 20 weight percent of a filler; based on the total weight of the encapsulated sweetener composition and a sweetener, wherein the encapsulating material at least partially encapsulates the sweetener.

Another embodiment is a chewing gum composition comprising: a gum base, an unencapsulated sweetener, and an encapsulated sweetener comprising an encapsulating material comprising a poly(vinyl acetate), about 2 to about 20 weight percent of a fatty acid salt selected from the group consisting of alkali metal fatty acid salts, alkaline earth metal fatty acid salts, and combinations thereof, based on the total weight of the encapsulated sweetener, and about 2 to about 20 weight percent of a filler; based on the total weight of the encapsulated sweetener composition and a sweetener, wherein the encapsulating material at least partially encapsulates the sweetener.

One embodiment is a method of preparing a chewing gum composition comprising: melt blending a poly(vinyl acetate), about 2 to about 20 weight percent of a fatty acid salt selected from the group consisting of alkali metal fatty acid salts, alkaline earth metal fatty acid salts, and combinations thereof, and about 2 to about 20 weight percent of a filler; and a sweetener to form an encapsulated sweetener composition; wherein the encapsulating material at least partially encapsulates the sweetener and wherein all weight percents are based on the total weight of the encapsulated sweetener composition; and then melt blending a gum base and the encapsulated sweetener composition to form a chewing gum composition.

Another embodiment is a method of preparing an encapsulated sweetener composition comprising: melt blending a poly(vinyl acetate), about 2 to about 20 weight percent of a fatty acid salt selected from the group consisting of alkali metal fatty acid salts, alkaline earth metal fatty acid salts, and combinations thereof, and about 2 to about 20 weight percent of a filler; and a sweetener to form an encapsulated sweetener composition; wherein the encapsulating material at least partially encapsulates the sweetener and wherein all weight percents are based on the total weight of the encapsulated sweetener composition.

These and other embodiments are described in detail below.

### BRIEF DESCRIPTION OF THE FIGURES

FIG. 1 is a plot showing the percent of sweetener released (%) versus time (hours: minutes: seconds) for the dissolution profiles of the sweetener encapsulations of Example 1 and Comparative Example 1.

FIG. 2 is a bar chart showing the gum hardness as a function of chewing time (minutes) for the chewing gums of (a) Comparative Example 4, which is a chewing gum containing sweetener encapsulated with poly(vinyl acetate) alone, and (b) Example 4, which is a chewing gum containing sweetener encapsulated with poly(vinyl acetate), fatty acid salt and a filler).

FIG. 3 is a bar chart showing the gum sweetness as a function of chewing time (minutes) for the chewing gums of (a) Comparative Example 4, which is a chewing gum containing sweetener encapsulated with poly(vinyl acetate) alone, and (b) Example 4, which is a chewing gum containing sweetener encapsulated with poly(vinyl acetate), fatty acid salt and a filler).

### DETAILED DESCRIPTION OF THE INVENTION

The present invention is directed to a delivery system used to extend or delay the release of a sweetener from an oral composition such as a foodstuff, a pharmaceutical or a personal care product. Preferred foodstuffs include chewing gum, confectionery, hard boilings and other sugar-based candies, jellies, soft candies, edible films, lozenges, pressed tablets, cereal bars, and the like. Pharmaceuticals can be delivered in the form of a chewing gum, tablet, capsule, solution, tincture, linctus, syrup, and the like. Confectionery and solid pharmaceutical delivery forms optionally can be coated. Exemplary personal products include chewing gum, toothpaste, mouth spray, and mouth wash.

In some embodiments, the oral composition can be a frozen or refrigerated/perishable product. Such frozen or refrigerated foodstuffs can include, but are not limited to, frozen desserts, frozen confections, yogurts, puddings, frozen baked goods and whipped toppings.

In some embodiments, the oral composition can include a gum base and any of the encapsulated sweetener compositions described herein. In some embodiments, some or all of the sweetener is in an encapsulated form. As a further alternative, oral composition can include some of the sweetener in an encapsulated form and some of the sweetener in a free form. In some embodiments, the chewing gum may include two or more encapsulated sweetener compositions.

As used herein, the term “encapsulated sweetener composition” and other similar terminology refers to the sweetener or sweetening agent once it is at least partially encapsulated with the encapsulating material. The encapsulating material is comprised of at least a polymer, a fatty acid salt, and a filler. The encapsulated sweetener composition can optionally further comprise additional ingredients and actives. The term “encapsulated sweetener composition” is synonymous with the term “encapsulated sweetener.”

As used herein, the term “encapsulate,” “encapsulates,” “encapsulation” or other similar terminology refers to a coating layer or polymer matrix that either at least partially surrounds a sweetener or sweetening agent. The coating layer or polymer matrix can also herein be referred to as “an encapsulation material,” “encapsulation layer,” or “encapsulation matrix.”

As used herein, the term “at least partially” when used in the context of the encapsulated sweetener composition means that the encapsulating material either partially or completely surrounds or encapsulates the sweetener.

The present invention is directed to compositions and methods of preparing a sweetener encapsulated in poly(vinyl acetate), a filler, and a fatty acid salt and to chewing gum compositions containing the same that can provide the end-user with a prolonged or delayed taste experience. More specifically, upon mastication the user can experience a prolonged and/or delayed release of flavorings, sweeteners, and food acids while maintaining a soft chew texture of the gum. For example, to extend the perception of sweetness a greater amount of encapsulated sweetener composition must be incorporated into the chewing gum, which incorporates more polymer, such as poly(vinyl acetate), into the chewing gum base as the chewing gum is masticated. This in turn deteriorates the late chew texture by hardening the chewing gum bolus.

In addition, the methods of preparing the encapsulated sweetener composition and chewing gum of the present invention provide a means to encapsulate a thermally degradable sweetener in a high molecular weight polymer. This provides encapsulated sweetener compositions and chewing gum compositions having improved long-lasting properties that delay the release of the sweeteners from the polymer matrix, which in turn provides chewing gums wherein the perception of sweetness is extended for the user during mastication. The methods of the present invention further provide a method of encapsulating a thermally degradable sweetener in a high molecular weight polymer by allowing the sweetener to be exposed to higher processing temperatures without degrading the sweetener, thereby improving the process stability.

According to the present invention it has unexpectedly been found that encapsulating a sweetener in poly(vinyl acetate), a filler, and a fatty acid salt can extend or delay the release of the sweetener by allowing the encapsulation of the sweetener in a high molecular weight polymer. The poly(vinyl acetate), filler, and fatty acid salt encapsulated sweetener compositions can further be incorporated into a chewing gum composition in order to more precisely control the intensity of and timing of the sweet flavor as experienced by the end-user without deteriorating the late chew texture of the chewing gum. The use of about 2 to about 20 weight percent fatty acid salt and about 2 to about 20 weight percent filler was important to achieve the desired combination of reduced gum hardness at long chewing times and encapsulated acid with physical integrity and improved process stability. When the fatty acid salt amount was significantly less than 2 weight percent, the chewing gum texture becomes hard upon mastication and no improvement in softness of the chewing gum bolus is observed. And when the fatty acid salt amount was significantly greater than 20 weight percent, a free fatty acid formed as a liquid and the separation of these liquid fatty acids/stearates from the encapsulated polymer matrix was observed. When the filler amount was significantly less than 2 weight percent, no improvement in processability is observed. And when the filler amount was significantly greater than 20 weight percent, the encapsulation polymer matrix weakens resulting in a loss of the controlled release efficacy.

In one embodiment there is an encapsulated sweetener composition that contains poly(vinyl acetate), a fatty acid salt, a filler and a sweetener. In another embodiment, the encapsulated food-grade active ingredient is incorporated into a chewing gum that further includes a gum base.

One embodiment is a method of preparing a chewing gum composition comprising: melt blending an encapsulating agent comprising a poly(vinyl acetate), about 2 to about 20 weight percent of a fatty acid salt, about 2 to about 20 weight percent of a filler, and a sweetener to form an encapsulated sweetener composition; wherein all weight percents are based on the total weight of the encapsulated sweetener composition; and melt blending a gum base and the encapsulated sweetener composition to form a chewing gum composition.

In some embodiments, the poly(vinyl acetate) has a weight average molecular weight of at least 75,000 atomic mass units. In some embodiments, the poly(vinyl acetate) weight average molecular weight is 75,000 to about 500,000 atomic mass units, more specifically about 80,000 to about 300,000 atomic mass units.

The poly(vinyl acetate) can be present in an amount of about 35 to about 90 weight percent of the encapsulated sweetener composition. In some embodiments, the poly(vinyl acetate) is present in an amount of about 35 to about 80 weight percent, specifically about 35 to about 75 weight percent, more specifically about 40 to about 60 weight percent of the encapsulated sweetener composition.

As used herein, the term “fatty acid salt” is meant to include any alkali metal or alkaline earth metal salt of a C₁₆-C₃₆ aliphatic carboxylic acid suitable for use in food-grade applications. Suitable fatty acid salts used to prepare the encapsulated sweetener composition include, for example, a sodium salt of a C₁₆-C₃₆ aliphatic carboxylic acid, a potassium salt of a C₁₆-C₃₆ aliphatic carboxylic acid, a calcium salt of a C₁₆-C₃₆ aliphatic carboxylic acid, a magnesium salt of a C₁₆-C₃₆ aliphatic carboxylic acid, and combinations thereof. In the context of the above-mentioned fatty acid salts, suitable C₁₆-C₃₆ aliphatic carboxylic acids include saturated fatty acids such as, for example, palmitic acid, stearic acid, arachidic acid, behenic acid, lignoceric acid, and cerotic acid. Also in the context of the above-mentioned fatty acid salts, C₁₆-C₃₆ aliphatic carboxylic acids further include unsaturated fatty acids such as, for example, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, and docosahexaenoic acid.

In some embodiments, the fatty acid salt is selected from alkaline earth metal stearates, alkali metal stearates, and combinations thereof. In some embodiments, the fatty acid salt comprises an alkaline earth metal stearate. In still other embodiments, the fatty acid salt is a magnesium salt of a C₁₆-C₃₆ aliphatic carboxylic acid or a calcium salt of a C₁₆-C₃₆ aliphatic carboxylic acid, such as magnesium stearate, calcium stearate, or a combination thereof. The fatty acid salt is present in an amount of about 2 to about 20 weight percent, based on the total weight of the encapsulated sweetener composition. In some embodiments, the fatty acid salt amount is about 5 to about 15 weight percent, specifically about 9 to about 12 weight percent.

Alkaline earth metal stearates, such as for example, calcium and magnesium stearates, have superior texture modification properties compared to alkali metal stearates, such as for example, sodium and potassium stearates, since the alkaline earth metal stearates are retained by the gum bolus for a longer period of time due to their lower water solubility. Alkaline earth metal stearates, also reduce the viscosity of the polymer melt without altering the mechanical properties of the polymer which allows the extrusion high molecular weight polymers at lower extruder barrel temperatures. Extrusion of high molecular weight polymers at lower temperatures allows for the inclusion of thermally unstable components, such as for example, thermally degradable sweeteners. However, the mechanical strength of the polymer matrix is not altered, thereby allowing the inclusion of components that could not previously be incorporated in a high-strength, high molecular weight polymer matrix due to the high processing temperatures.

Further, alkaline earth metal stearates function as acid scavengers to prevent thermal decomposition and darkening of the sweeteners, which indicates thermal decomposition of the sweeteners. Certain sweeteners, such as for example, TwinSweet (aspartame and acesulfame potassium) and sucralose, contain or are capable of generating acidic moieties that catalyze the decomposition of the polymer matrix as well as the sweetener, which results in a darkening of the sweetener that is indicated by yellowing, browning, or charring of the sweetener. This reaction proceeds autocatalytically and is therefore very difficult to stop once the reaction begins. Alkaline earth metal stearates neutralize these acidic moieties, which by interrupts the decomposition reaction pathway, thereby preventing the acidic decomposition by-products that cause discoloration of the sweetners.

Suitable sweeteners used to prepare the encapsulated sweetener composition include, for example, sugar sweeteners, sugarless sweeteners, high intensity sweeteners, or a combination thereof. Suitable sweeteners can include any of the sweeteners or sweetening agents recited herein. In an embodiment, the sweetener includes lo han guo, sucralose, monatin, rebaudioside A, steviosides, acesulfame potassium, aspartame, aspartame-acesulfame, or combinations thereof. In another embodiment, the sweetener is selected from lo han guo, sucralose, monatin, aspartame-acesulfame, and combinations thereof. The encapsulated sweetener composition can include the sweetener in an amount of about 5 to about 50 weight percent, based on the total weight of the encapsulated sweetener composition. In some embodiments, the sweetener amount is about 10 to about 40 weight percent, specifically about 20 to about 40 weight percent. In an embodiment, the encapsulated sweetener composition includes sucralose in an amount of about 20 to about 40 weight percent.

In some embodiments, the sweetener that is used to form the encapsulated sweetener composition has a number average particle size of about 1 to about 400 micrometers. In some embodiments, the sweetener has a number average particle size of about 1 to about 200 micrometers, specifically about 10 to about 100 micrometers, more specifically about 10 to about 75 micrometers.

As used herein, the term “filler” when used in the context of the encapsulated sweetener composition refers to an inert powder material that is included in the polymer matrix/encapsulating material in order to improve processability, improve the structural integrity of the polymer matrix, and reduce the manufacturing costs.

Suitable fillers used to prepare the encapsulated sweetener composition include, for example, talc, calcium carbonate, dicalcium phosphate, silica, and combinations thereof. Suitable fillers can include any of the fillers recited herein. In some embodiments, the filler includes talc. The encapsulated sweetener composition can include the filler in an amount of about 2 to about 20 weight percent, based on the total weight of the encapsulated sweetener composition. In some embodiments, the sweetener amount is about 2 to about 15 weight percent, specifically about 2 to about 12 weight percent.

In some embodiments, the encapsulated sweetener composition further comprises one or more additional active ingredients that can be added to the sweetener prior to encapsulating the sweetener in the delivery system. Such active ingredients can include, for example, flavorings, food-grade acids, oral care agents, antioxidants, nutraceuticals, pharmaceutical actives, and combinations thereof. In an embodiment the active ingredient is a food-grade acid that is a solid at 25 degrees Celsius and one atmosphere.

In a preferred embodiment, the encapsulated sweetener composition comprises the fatty acid salt in an amount of about 2 to about 20 weight percent, and the filler in an amount of about 2 to about 20 weight percent. In another preferred embodiment, the encapsulated sweetener composition comprises the fatty acid salt in an amount of about 2 to about 20 weight percent, the sweetener in an amount of about 5 to about 50 weight percent, the filler in an amount of about 2 to about 20 weight percent, and the poly(vinyl acetate) in an amount of about 35 to about 90 weight percent.

In one embodiment of the encapsulated sweetener composition the fatty acid salt and the sweetener are present in a weight ratio of about 1:0.25 to about 1:25. In some embodiments, the fatty acid salt and the sweetener are present in a weight ratio of about 1:0.66 to about 1:8 more specifically about 1:1.6 to about 1:4.4. In one embodiment of the encapsulated sweetener composition the fatty acid salt and the poly(vinyl acetate) are present in a weight ratio of about 1:1.75 to about 1:45. In some embodiments, the fatty acid salt and the poly(vinyl acetate) are present in a weight ratio of about 1:2.3 to about 1:16 more specifically about 1:3.3 to about 1:6. In one embodiment of the encapsulated sweetener composition the sweetener and the poly(vinyl acetate) are present in a weight ratio of about 1:0.7 to about 1:18. In some embodiments, the sweetener and the poly(vinyl acetate) are present in a weight ratio of about 1:0.875 to about 1:8 more specifically about 1:1 to about 1:3.

In one preferred embodiment, the fatty acid salt is magnesium stearate, calcium stearate, or combinations thereof; the sweetener is lo han guo, sucralose, monatin, rebaudioside A, steviosides, acesulfame potassium, aspartame, aspartame-acesulfame, and combinations thereof; the filler is talc; the sweetener has a number average particle size of about 1 to about 400 micrometers; the encapsulated sweetener composition comprises the fatty acid salt and the sweetener in a weight ratio of about 1:0.25 to about 1:25; the encapsulated sweetener composition comprises the fatty acid salt and the poly(vinyl acetate) in a weight ratio of about 1:1.75 to about 1:45; the encapsulated sweetener composition comprises the sweetener and the poly(vinyl acetate) in a weight ratio of about 1:0.7 to about 1:18; the encapsulated sweetener composition particles have a number average particle size less than or equal to 420 micrometers; wherein the chewing gum composition comprises about 0.25 to about 11 weight percent of the encapsulated sweetener composition; and the chewing gum further comprises a free (unencapsulated) sweetener, a free (unencapsulated) food-grade acid, or combinations thereof.

### Chewing Gum

As used herein, the terms “gum,” “chewing gum,” and “bubble gum” are used interchangeably and are meant to include any gum composition. With regard to chewing gum compositions, such compositions contain a gum base, the flavor enhancing composition, and various additives.

In one embodiment the encapsulated sweetener composition is incorporated into a chewing gum. The chewing gum includes a gum base and an unencapsulated sweetener in addition to the encapsulated sweetener composition. The amount of the encapsulated sweetener composition can be about 0.25 to about 11 weight percent, specifically about 1 to about 10 weight percent, more specifically about 2 to about 9 weight percent, even more specifically about 3 to about 7 weight percent, based on the weight of the chewing gum composition. In some embodiments, the encapsulated sweetener composition is present in a chewing gum composition in a particulate form having a number average particle size less than or equal to about 500 micrometers. In some embodiments, the encapsulated sweetener composition is present in a chewing gum composition in a particulate form having a number average particle size of about 5 to about 500 micrometers, specifically about 10 to about 450 micrometers, more specifically about 20 to about 420 micrometers. In some embodiments the encapsulated sweetener composition is present in a chewing gum composition in a particulate form having a number average particle size of about 420 micrometers.

The chewing gum composition generally comprises a gum base, bulk sweeteners, high intensity sweeteners, flavorants, coloring agents, warming agents, cooling agents, tingling agents, and any other optional additives, including throat-soothing agents, spices, tooth-whitening agents, breath-freshening agents, vitamins, minerals, caffeine, drugs (e.g., medications, herbs, and nutritional supplements), oral care products, and combinations comprising at least one of the foregoing.

Generally, the chewing gum composition comprises a water-insoluble gum base portion and a bulk portion comprising of additional ingredients (also known as additives). The gum base can vary greatly depending upon various factors such as the type of base desired, the consistency of gum desired, and the other components used in the composition to make the final chewing gum product. In some embodiments, the chewing gum base is present in an amount of about 5 to about 90 weight percent, where the weight percent is based on the total weight of the chewing gum composition. Within the range of about 5 to about 90, the water-insoluble gum base can be present in an amount of about 10 to about 50 weight percent, specifically the gum base can be present in an amount of about 15 to about 40 weight percent, and even more specifically the gum base can be present in an amount of about 20 to about 30 weight percent.

As used herein, the term “water-soluble” encompasses compounds, which possess a water solubility of at least 1 gram/liter at 25 degree Celsius. As used herein, the term “water-insoluble” encompasses compounds, which possess a water solubility of less than at least 1 gram/liter at 25 degree Celsius.

The gum base can be any water-insoluble gum base known in the art, and includes those gum bases utilized for chewing gums and bubble gums. Illustrative examples of suitable polymers in gum bases include both natural and synthetic elastomers and rubbers. For example, natural elastomers and rubbers include substances of vegetable origin such as smoked or liquid latex and guayule, natural gums such as jelutong, lechi caspi, perillo, sorva, massaranduba balata, massaranduba chocolate, nispero, rosidinha, crown gum, chicle, gutta percha, gutta kataiu, gutta kay, niger gutta, tunu, chilte, chiquibul, gutta hang kang, or the like, and mixtures thereof.

Synthetic elastomers include high- and low-molecular weight elastomers. Useful high molecular weight elastomers include butadiene-styrene copolymers, polyisoprene, polyisobutylene, isobutylene-isoprene copolymers, polyethylene, combinations thereof, and the like. Useful low-molecular weight elastomers include polybutene, polybutadiene, polyisobutylene, and combinations thereof. Suitable gum bases can also include vinyl polymeric elastomers such as poly(vinyl acetate) (PVA), polyethylene, vinyl copolymeric elastomers such as copolymers of vinyl acetate and vinyl laurate, copolymers of vinyl acetate and vinyl stearate, copolymers of ethylene and vinyl acetate, poly(vinyl alcohol) and combinations thereof. When utilized, the number average molecular weight of the vinyl polymers can range about 3,000 to about 94,000. Vinyl polymers such as poly(vinyl alcohol) and poly(vinyl acetate) (when employed in the gum base, as distinguished from the encapsulated sweetener composition) can have a number average molecular weight of about 8,000 to about 65,000. Furthermore, any combination of the aforementioned high- and low-molecular weight, natural and synthetic elastomers, and rubbers can be used as a gum base. The polymers can be present in an amount of about 35 to about 95 weight percent, based on the weight of the gum base.

The amount of gum base employed will vary greatly depending upon various factors such as the type of base used, the consistency of the gum desired, and the other components used in the composition to make the final chewing gum product. In general, the gum base will be present in an amount of about 5 to about 94 weight percent of the final chewing gum composition. In some embodiments, the gum base amount is about 15 to about 45 weight percent, specifically about 20 to about 43 weight percent, more specifically about 30 to about 40 weight percent, based upon the total weight of the chewing gum composition.

The water-insoluble gum base portion can further additionally contain any combination of elastomer plasticizers, waxes, softeners, bulking agents and other optional ingredients such as colorants and antioxidants. Elastomer plasticizers are also commonly referred to as resins, resinous compounds, elastomer solvents, or rosins. Additives that can be included in the gum base include plasticizers, waxes or softeners that are used in effective amounts to provide a variety of desirable textures and consistency properties. Because of the low molecular weight of these components, the texture modifying agents are able to penetrate the fundamental structure of the gum base making it more plastic and less viscous.

The gum base composition can contain conventional elastomer plasticizers to aid in softening the elastomer base component, for example terpene resins such as polymers derived from alpha-pinene beta-pinene, and/or d-limonene; methyl, glycerol or pentaerythritol esters of rosins or modified rosins and gums, such as hydrogenated, dimerized or polymerized rosins, or combinations comprising at least one of the foregoing resins; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like. Any combination of the foregoing elastomer plasticizers can be used to soften or adjust the tackiness of the elastomer base component. The elastomer plasticizer can be used in an amount of about 5 to about 75 weight percent of the gum base, specifically about 45 to about 70 weight percent of the gum base. In some embodiments, the chewing gum composition further contains a gum base softener. In some embodiments, the softener is present in amounts of up to about 30 weight percent of the gum base, specifically about 3 to about 20 weight percent of the gum base. In some embodiments, the softeners can be present in amounts of up to about 30 weight percent of the gum base, specifically about 0.1 to about 20 weight percent of the gum base, more specifically about 0.1 to about 4 weight percent of the gum base, still more specifically about 0.20 to about 2.5 weight percent of the gum base, and even more specifically about 0.5 to about 1.7 weight percent of the gum base. Suitable softeners include lanolin, palmitic acid, oleic acid, stearic acid, fatty acids, sodium stearate, potassium stearate, glyceryl triacetate, glyceryl lecithin, glyceryl monostearate, propylene glycol monostearate, mono-, di- and triglycerides, acetylated monoglyceride, glycerine, lecithin, diacetin, and combinations thereof. Other suitable softeners include waxes. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, cocoa butter, propylene glycol, and the like can also be incorporated into the gum base to obtain a variety of desirable textures and consistency properties. The waxes employed can have a melting point below about 60 degrees Celsius, and preferably about 45 to about 55 degrees Celsius. The low melting wax can be a paraffin wax. The wax can be present in the gum base in an amount about 6 to about 10 weight percent, and preferably about 7 to about 9.5 weight percent, based on the total weight of the gum base. In addition to the low melting point waxes, waxes having a higher melting point can be used in the gum base in amounts up to about 5 weight percent based on the weight of the gum base. Such high melting waxes include beeswax, vegetable wax, rice bran wax, candelilla wax, carnauba wax, polyethylene wax, microcrystalline wax, petroleum waxes, and the like, and mixtures thereof.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, which can serve as fillers and textural agents. These fillers or adjuvants can be used in the gum base in various amounts and are in addition to the filler in the encapsulated sweetener composition. Specifically the amount of filler, when used, will be present in an amount of about 15 to about 40 weight percent, specifically about 20 to about 30 weight percent, based on the weight of the gum base.

In addition to the water insoluble gum base portion, a typical chewing gum composition includes a water soluble bulk portion and one or more flavoring agents. In some embodiments, the sweetener is present in a water soluble bulk portion of the chewing gum composition. The water soluble bulk portion can include one or more additional ingredients selected from the group consisting of sweetening agents, flavorants or flavoring agents, flavor modulators or potentiator, aroma agents, cooling agents, warming agents, coloring agents, breath fresheners, mouth moisteners, humectants, food-grade acids, buffering agents, tingling agents, effervescing agents, mouth moisteners, oral care agents, throat care agents, medicaments, antioxidants, preservatives, and combinations thereof. Some of these additional ingredients can serve more than one purpose. For example, a sweetening agent such as sucrose, sorbitol, other sugar alcohols, and combinations thereof can also function as a bulking agent. A combination comprising at least one of the foregoing additional ingredients is often used.

In some embodiments, the gum composition includes one or more unencapsulated active ingredients in addition to the encapsulated sweetener composition. The additional active ingredients can be unencapsulated active ingredients, encapsulated active ingredients or mixtures thereof. Any of the active ingredients herein described can be used as the additional active ingredient. In one embodiment, the unencapsulated active ingredients are present in an amount about 0.1 to about 50 weight percent based upon the total weight of the chewing gum composition. In one embodiment, the unencapsulated active ingredients are present in an amount about 0.1 to about 2.0 weight percent based upon the total weight of the chewing gum composition, specifically about 0.25 to about 1.5 weight percent, more specifically about 0.5 to about 1.0 weight percent of the chewing gum composition. In another embodiment, the unencapsulated active ingredients are present in an amount about 9.0 to about 49.0 weight percent based upon the total weight of the chewing gum composition, specifically about 9.0 to about 39.0 weight percent, more specifically about 10.0 to about 35.0 weight percent of the chewing gum composition.

In some embodiments, the chewing gum includes a sweetening agent to provide a sweet taste to the gum composition. Sweetening agents can include sugar sweeteners, sugarless sweeteners, high intensity sweeteners, or a combination of at least two of the foregoing sweetening agents.

Sugar sweeteners generally include saccharides. Suitable sugar sweeteners include monosaccharides, disaccharides and polysaccharides such as sucrose (sugar), dextrose, maltose, dextrin, xylose, ribose, glucose, mannose, galactose, fructose (levulose), lactose, invert sugar, fructooligosaccharide syrups, partially hydrolyzed starch, corn syrup solids, such as high fructose corn syrup, and mixtures thereof.

Suitable sugarless sweetening agents include sugar alcohols (or polyols) such as sorbitol, xylitol, mannitol, galactitol, maltitol, hydrogenated isomaltulose (isomalt), lactitol, erythritol, hydrogenated starch hydrolysate, stevia and mixtures thereof. Suitable hydrogenated starch hydrolysates include those disclosed in U.S. Pat. No. 4,279,931 to Verwaerde et al. and various hydrogenated glucose syrups and/or powders, which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Also useful are mixtures of hydrogenated starch hydrolysates, such as those sold under the trade name LYCASIN by Roquette Freres of France, and those sold under the trade name HYSTAR by Lonza, Inc., of Fair Lawn, N.J., USA.

A “high intensity sweetener” as used herein means agents having a sweetness at least 100 times that of sugar (sucrose) on a per weight basis, specifically at least 500 times that of sugar on a per weight basis. In one embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Any combination comprising two or more high intensity sweetener can be used. One or more of the high intensity sweeteners can further be combined with one or more of the foregoing sweeteners or sweetening agents. The high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, and combinations of the foregoing forms.

Without being limited to particular sweetening agents, representative categories and examples include: (1) water-soluble sweetening agents such as dihydrochalcones, monellin, steviosides, Rebaudioside A, Rebaudioside B, Rebaudioside C, glycyrrhizin, dihydroflavenol, and sugar alcohols such as sorbitol, mannitol, maltitol, monatin, and L-aminodicarboxylic acid aminoalkenoic acid ester amides, such as those disclosed in U.S. Pat. No. 4,619,834 to Zanno et al., and combinations thereof; (2) water-soluble artificial sweeteners such as saccharin, soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and combinations thereof; (3) dipeptide based sweeteners, for example the L-aspartic acid derived sweeteners such as L-aspartyl-L-phenylalanine methyl ester (Aspartame) and materials described in U.S. Pat. No. 3,492,131 to Schlatter, L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenylglycine, L-alpha-aspartyl-L-phenylglycine methyl ester, L-alpha-aspartyl-L-2,5-dihydrophenylglycine methyl ester, L-aspartyl-2,5-dihydro-L-phenylalanine; L-alpha-aspartyl-2,5-dihydrophenylalanine methyl ester, L-aspartyl-L-(1-cyclohexen)-alanine, N—(N-(3,3-dimethylbutyl)-L-alpha-aspartyl)-L-phenylalanine methyl ester (Neotame), or a combination thereof; (4) derivatives of water-soluble sweeteners, such as steviosides, Rebaudioside A, Rebaudioside B, Rebaudioside C, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose; 1,6-dichloro-1,6-dideoxy-β-D-fructofuranosyl-4-chloro-4-deoxy-α-D-galactopyranoside; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; 4,6,1′,6′-tetradeoxy-sucrose, and combinations thereof; (5) protein based sweeteners such as thaumatococcous danielli, thaumatin, talin; mogrosides (lo han guo); and combinations thereof; and (6) amino acid based sweeteners.

In some embodiments, the sweeteners include sorbitol, mannitol, aspartame, acesulfame potassium salt, and combinations thereof. The sweeteners can be present in a suitable amount depending upon the desired level of sweetness. In some embodiments the sweeteners are present in an amount of about 35 to about 80 weight percent of the chewing gum composition. Within the range of about 35 to about 80, the amount can be about 45 to about 75 weight percent, specifically the amount can be about 50 to 65 weight percent.

In another preferred embodiment the chewing gum can further include unencapsulated sweeteners. Suitable unencapsulated sweeteners include any of the sweeteners recited herein. In some embodiments, the unencapsulated sweeteners include sugar alcohols, polyols, and mixtures thereof. In some embodiments, the unencapsulated sweeteners include sorbitol, mannitol, and mixtures thereof. In one embodiment, the unencapsulated active ingredients are present in an amount about 5.0 to about 50 weight percent based upon the total weight of the chewing gum composition. In one embodiment, the unencapsulated sweeteners are present in an amount about 9.0 to about 49.0 weight percent based upon the total weight of the chewing gum composition. In one embodiment, the unencapsulated sweeteners are present in an amount about 9.0 to about 39.0 weight percent based upon the total weight of the chewing gum composition. In some embodiments, the unencapsulated sweeteners are present in an amount of about 10.0 to about 35.0 weight percent of the chewing gum composition.

In a chewing gum product, a sweet taste can come from flavorants or flavoring agents, and/or from flavor modulators or potentiators. Flavor modulators can impart a characteristic of their own that complements or negates a characteristic of another component. For example, flavors can be compounded to have additional sweet notes by the inclusion of flavor modulators or potentiators, such as vanilla, vanillin, ethyl maltol, furfural, ethyl propionate, lactones, and combinations thereof. The flavor modulators can be used in the amount about 0.01 to about 30 weight percent of the chewing gum composition depending on the desired intensity of the aromas used. Preferably, the content of the flavor modulators is in the range of about 0.2 to about 3 weight percent of the chewing gum composition.

Flavorants (also known as flavorings, flavors or flavoring agents) that can be used include those artificial and natural flavors known in the art, for example synthetic flavor oils, natural flavoring aromatics and/or oils, oleoresins, extracts derived from plants, leaves, flowers, fruits, and the like, and combinations comprising at least one of the foregoing flavorants. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, and combinations thereof. Specific flavorants are mints such as peppermint, spearmint, artificial vanilla, cinnamon derivatives, and various fruit flavors.

Examples of artificial, natural and synthetic fruit flavorings include coconut, coffee, chocolate, vanilla, lemon, grapefruit, orange, lime, yazu, sudachi, menthol, licorice, caramel, honey, peanut, walnut, cashew, hazelnut, almonds, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and the like, and combinations thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), 2-dodecenal (citrus, mandarin), and combinations thereof.

Other potential flavors whose release profiles can be managed include a milk flavor, a butter flavor, a cheese flavor, a cream flavor, a yogurt flavor, a vanilla flavor, a tea or coffee flavor, such as a green tea flavor, a oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, Zanthoxyli Fructus, perilla, juniper berry, ginger, star anise, horseradish, thyme, a tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, and tomato. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the composition can further include fruit juices.

The flavoring agents can be used in many distinct physical forms. Such physical forms include liquid and/or dried form. In some embodiments, the flavoring agents can be in free (unencapsulated) forms, spray dried forms, freeze dried forms, powdered forms, beaded forms, encapsulated forms, slices, pieces, and mixtures thereof. When employed in a spray-dried form, suitable drying means such as spray drying a liquid can be used. Alternatively, the flavoring agent can be absorbed onto water soluble materials, such as cellulose, starch, sugar, maltodextrin, gum arabic and so forth or it can be encapsulated. In still other embodiments, the flavoring agent can be adsorbed onto silicas, zeolites, and the like. The particle size of the flavorings can be less than 3 millimeters, less than 2 millimeters or preferably less than 1 millimeter, calculated as the longest dimension of the particle. The natural flavoring agent can have a particle size of about 3 micrometers to about 2 millimeters, specifically about 4 micrometers to about 1 millimeter. The flavorants can be used in the amount about 0.01 to about 30 weight percent of the gum composition depending on the desired intensity of the aromas used. Preferably, the content of the flavorants is in the range of about 0.2 to about 3 weight percent of the gum composition.

Flavor potentiators are materials that intensify, supplement, modify or enhance the taste or aroma perception of an original material without introducing a characteristic taste or aroma perception of their own. In some embodiments, flavor potentiators are designed to intensify, supplement, modify, or enhance the perception of flavor, sweetness, tartness, umami, kokumi, saltiness or a combination thereof. The flavor potentiators can be used in the amount about 0.01 to about 30 weight percent of the gum composition depending on the desired intensity of the aromas used. Preferably, the content of the flavor potentiators is in the range of about 0.2 to about 3 weight percent of the gum composition. Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), and combinations thereof. In some embodiments, the flavor modulator or potentiator is selected from sugar acids, sodium chloride, potassium chloride, sodium acid sulfate, and combinations thereof. In other embodiments, the flavor modulator or potentiator is selected from glutamates such as monosodium glutamate, monopotassium glutamate, hydrolyzed vegetable protein, hydrolyzed animal protein, yeast extract, and combinations thereof. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

The amount of flavorants, flavor modulators, and flavor potentiators used herein can be a matter of preference subject to such factors as the type of final comestible product composition, the individual flavor, the confectionary base employed, and the strength of flavor desired. Thus, the amount of flavoring can be varied in order to obtain the result desired in the final product and such variations are within the capabilities of those skilled in the art without the need for undue experimentation.

In some embodiments, the chewing gum can contain aroma agents and/or flavoring agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The flavorings can be in liquid or powdered form.

In some embodiments, the chewing gum contains aroma agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The aroma agents can be in liquid or powdered form. In some embodiments, the encapsulated sweetener composition further contains a flavoring, any of the flavoring described herein are suitable for use. The aroma agents and/or flavors can be used in the amount of about 0.01 to about 30 weight percent of the gum composition depending on the desired intensity of the aromas and/or flavors used. Preferably, the content of the aromas and/or flavors is in the range of about 0.2 to about 4 weight percent of the gum composition.

In some embodiments, the chewing gum can also deliver multiple, distinct flavors to the consumer resulting in a flavor-changing gum composition. In one embodiment, the chewing gum composition contains a poly(vinyl acetate) and fatty acid salt encapsulated sweetener composition, as described herein, and further contains at least a first flavor composition and a second flavor composition, wherein the first flavor composition begins to release from the chewing gum when the chewing gum composition is masticated, and the second flavor composition comprising the encapsulated sweetener composition begins to release after the first flavor composition has begun to release. In another embodiment, the chewing gum includes a third flavor composition that begins to release after the second flavor composition.

In other embodiments, the chewing gum composition delivers multiple, distinct flavors such as, for example, sweet flavors, sour flavors, fruit flavors, mint flavors and the like, including any of the flavorings and/or sensates disclosed herein. The sweet and sour flavors can be released in any sequential order or combination. For example, in one embodiment of the gum composition the first flavor composition is a sweet flavor and the second flavor composition is a sour flavor. In another embodiment, the first flavor composition is a sweet flavor, the second flavor composition is a sour flavor, and the third flavor composition is a sweet flavor.

In some embodiments, the first flavor composition releases for about 5 minutes to about 7 minutes after mastication begins and the second flavor composition releases for about 8 minutes to about 10 minutes after mastication begins. In other embodiments, the first flavor composition releases for about 5 minutes to about 7 minutes after mastication begins, the second flavor composition releases for about 8 minutes to about 10 minutes after mastication begins, and the third flavor composition releases for about for about 10 minutes to about 30 minutes after mastication begins. In additional embodiments, the first flavor composition releases for about 6 minutes to about 7 minutes after mastication begins, the second flavor composition releases for about 7 minutes to about 12 minutes after mastication begins, and the third flavor composition releases for about for about 12 minutes to about 30 minutes after mastication begins.

The chewing gum can further include cooling and warming agents. Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2-propyl)-5-methyl-1-cyclohexanol) is available in artificial form, or naturally from sources such as peppermint oil. Menthol derivatives include menthyl ester-based and menthyl carboxamide-based cooling compounds such as menthyl carboxamide, N-ethyl-p-menthane carboxamide, monomenthyl succinate, monomenthyl methyl succinate, monomenthyl glutarate, menthyl 2-pyrrolidone-5-carboxylate, monomenthyl 3-methyl maleate, menthyl acetate, menthyl lactate, menthyl salicylate, 2-isopropanyl-5-methylcyclohexanol, 3-L-menthoxypropane-1,2-diol, menthane, menthone, menthone ketals, menthone glycerol ketals, menthyl glutarate esters, N-ethyl-p-menthane-3-carboxamide (WS-3), and combinations thereof. Additional menthyl-based coolants, specifically menthylcarboxamides, are described in U.S. Pat. No. 7,923,577 to Bardsley et al.

Other cooling agents that can be used in combination with or in the absence of the menthyl-based coolants include, for example 2-mercapto-cyclo-decanone, hydroxycarboxylic acids with 2 to 6 carbon atoms, xylitol, erythritol, alpha-dimethyl succinate, menthyl lactate, acyclic carboxamides such as N-2,3-trimethyl-2-isopropyl butanamide, and combinations thereof. Additional cooling agents include the 1-tert-butylcyclohexanecarboxamides described in U.S. Patent Application Publication Nos. US 2011/0070171 A1 and US 2011/0070329 A1 of Kazimierski et al.

Cooling compositions comprising a primary cooling compound, a secondary cooling compound, and an ingestible non-polar solvent are described in U.S. Patent Application Publication No. US 2011/0091531 A1 of Furrer et al. The cooling agents can be present in a suitable amount depending upon the desired level of cooling intensity. In some embodiments, the cooling agents are present in an amount of about 0.01 to about 1.5 weight percent of the chewing gum composition. Within the range of about 0.01 to about 1.5 weight percent, the cooling agents can be about 0.05 to about 1.25 weight percent, specifically the cooling agents can be about 0.1 to 1 weight percent.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerin, and combinations thereof. The warming agents can be present in a suitable amount depending upon the desired level of warming intensity. In some embodiments, the warming agents are present in an amount of about 0.01 to about 1.5 weight percent of the chewing gum composition. Within the range of about 0.01 to about 1.5 weight percent, the warming agents can be about 0.05 to about 1.25 weight percent, specifically the warming agents can be about 0.1 to 1 weight percent.

In some embodiments, a tingling sensation can be provided. Tingling agents include jambu, and alkylamides extracted from materials such as jambu or sanshool. Tingling agents can be present in a suitable amount depending upon the desired level of intensity. In some embodiments, the tingling agents are present in an amount of about 0.01 to about 2 weight percent of the chewing gum composition. Within the range of about 0.01 to about 2 weight percent, the tingling agents can be about 0.05 to about 1.25 weight percent; specifically, the tingling agents can be about 0.1 to 1 weight percent.

Additionally, a sensation can be created due to effervescence. Such effervescence is created by combining a basic material with an acidic material. In some embodiments, the basic material can include alkali metal carbonates, alkali metal bicarbonates, alkaline earth metal carbonates, alkaline earth metal bicarbonates, and combinations thereof. In some embodiments, the acidic material can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and combinations thereof. Effervescing agents can be present in a suitable amount depending upon the desired level of intensity. In some embodiments, the effervescing agents are present in an amount of about 0.01 to about 2 weight percent of the chewing gum composition. Within the range of about 0.01 to about 2 weight percent, the effervescing agents can be about 0.05 to about 1.25 weight percent; specifically, the effervescing agents can be about 0.1 to 1 weight percent.

Coloring agents (colorants, colorings) can be used in amounts effective to produce a desired color for the comestible. Suitable coloring agents include pigments, which can be incorporated in amounts up to about 6 weight percent of the chewing gum composition. For example, titanium dioxide can be incorporated in amounts up to about 2 weight percent, and specifically less than about 1 weight percent by weight of the chewing gum composition. Suitable coloring agents also include natural food colors and dyes suitable for food, drug, and cosmetic applications.

Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violaxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorubin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), FD&C aluminum lakes, and combinations thereof.

Exemplary breath fresheners that can be used in the chewing gum include zinc citrate, zinc acetate, zinc fluoride, zinc ammonium sulfate, zinc bromide, zinc iodide, zinc chloride, zinc nitrate, zinc fluorosilicate, zinc gluconate, zinc tartrate, zinc succinate, zinc formate, zinc chromate, zinc phenol sulfonate, zinc dithioate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, or a mixture comprising at least one of the foregoing. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, or a combination thereof. Aldehydes such as cinnamic aldehyde and salicylaldehyde can be used. Additionally, chemicals such as menthol, carvone, iso-garrigol, and anethole can function as breath fresheners. The breath fresheners can be present in a suitable amount depending upon the desired level of intensity. In some embodiments, the breath fresheners are present in an amount of about 0.01 to about 2 weight percent of the chewing gum composition. Within the range of about 0.01 to about 2 weight percent, the breath fresheners can be about 0.05 to about 1.25 weight percent; specifically, the breath fresheners can be about 0.1 to 1 weight percent.

Exemplary mouth moisteners include saliva stimulators such as acids and salts including acetic acid, adipic acid, ascorbic acid, butyric acid, citric acid, formic acid, fumaric acid, glyconic acid, lactic acid, phosphoric acid, malic acid, oxalic acid, succinic acid, and tartaric acid. Mouth moisteners can include hydrocolloid materials that hydrate and can adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carrageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination thereof. Modified celluloses can be included, such as microcrystalline cellulose, carboxymethylcellulose (CMC), methylcellulose (MC), hydroxypropylmethylcellulose (HPMC), hydroxypropylcellulose (HPC), or a combination thereof. The mouth moisteners can be present in a suitable amount depending upon the desired level of intensity. In some embodiments, the mouth moisteners are present in an amount of about 0.01 to about 2 weight percent of the chewing gum composition. Within the range of about 0.01 to about 2 weight percent, the mouth moisteners can be about 0.05 to about 1.25 weight percent; specifically, the mouth moisteners can be about 0.1 to 1 weight percent.

Similarly, humectants, which can provide a perception of mouth hydration, can be included. Such humectants can include glycerol, sorbitol, polyethylene glycol, erythritol, xylitol, or a combination thereof. Additionally, in some embodiments, fats can provide a perception of mouth moistening. Such fats can include medium chain triglycerides, vegetable oils, fish oils, mineral oils, or a combination thereof. The humectants can be present in a suitable amount depending upon the desired level of intensity. In some embodiments, the humectants are present in an amount of about 0.01 to about 2 weight percent of the chewing gum composition. Within the range of about 0.01 to about 2 weight percent, the humectants can be about 0.05 to about 1.25 weight percent; specifically, the humectants can be about 0.1 to 1 weight percent.

Suitable food-grade acids include acetic acid, citric acid, fumaric acid, hydrochloric acid, lactic acid and nitric acid as well as sodium citrate, sodium bicarbonate, sodium carbonate, sodium or potassium phosphate, magnesium oxide, potassium metaphosphate, sodium acetate, and combinations thereof. The acidulants can be present in a suitable amount depending upon the desired level of intensity. In some embodiments, the acidulants are present in an amount of about 0.1 to about 3 weight percent of the chewing gum composition. Within the range of about 0.1 to about 3 weight percent, the acidulants can be about 0.5 to about 2.5 weight percent; specifically, the humectants can be about 0.75 to 2 weight percent.

In a preferred embodiment the chewing gum can further include unencapsulated food-grade acids. Suitable unencapsulated acids include, for example, adipic acid, ascorbic acid, aspartic acid, benzoic acid, citric acid, fumaric acid, glutamic acid, maleic acid, malic acid, oxalic acid, phosphoric acid, sorbic acid, succinic acid, tartaric acid, and mixtures thereof. In some embodiments, the unencapsulated acids include citric acid, malic acid, and mixtures thereof. In one embodiment, the unencapsulated food-grade acids are present in an amount about 0.1 to about 2.0 weight percent based upon the total weight of the chewing gum composition. In one embodiment, the unencapsulated food-grade acids are present in an amount about 0.1 to about 2.0 weight percent based upon the total weight of the chewing gum composition. In some embodiments, the unencapsulated food-grade acids are present in an amount of about 0.25 to about 1.5 weight percent, more specifically about 0.5 to about 1.0 weight percent of the chewing gum composition.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof. The buffering agents can be present in a suitable amount depending upon the desired level of intensity. In some embodiments, the buffering agents are present in an amount of about 0.01 to about 2 weight percent of the chewing gum composition. Within the range of about 0.01 to about 2 weight percent, the buffering agents can be about 0.05 to about 1.25 weight percent; specifically, the buffering agents can be about 0.1 to 1 weight percent.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include hydrolytic agents including proteolytic enzymes, abrasives such as hydrated silica, calcium carbonate, sodium bicarbonate and alumina, other active stain-removing components such as surface-active agents, including anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. Oral care ingredients can also include tetrasodium pyrophosphate, sodium bicarbonate, sodium acid pyrophosphate, sodium tripolyphosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphosphate. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples can include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents include detersive materials that impart to the composition detersive and foaming properties. Suitable surfactants include sodium stearate, sodium ricinoleate, sodium lauryl sulfate, water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolammonium salts of N-lauroyl sarcosine, N-myristoyl sarcosine, or N-palmitoyl sarcosine.

In addition to surfactants, oral care ingredients can include antibacterial agents such as triclosan, chlorhexidine, zinc citrate, silver nitrate, copper, limonene, cetyl pyridinium chloride, and combinations thereof.

Anticaries agents include fluoride ion sources, such as sodium fluoride, potassium fluoride, sodium fluorosilicate, ammonium fluorosilicate, potassium fluoride, sodium monofluorophosphate, stannous fluoride, potassium stannous fluoride, sodium hexafluorostannate, stannous chlorofluoride, and combinations thereof.

Further examples of oral care agents are included in U.S. Pat. No. 5,227,154 to Reynolds, U.S. Pat. No. 5,378,131 to Greenberg, and U.S. Pat. No. 6,685,916 to Holme et al. Oral care agents can be present in a suitable amount depending upon the desired level of care. In some embodiments, the oral care agents are present in an amount of about 0.01 to about 2 weight percent of the chewing gum composition. Within the range of about 0.01 to about 2 weight percent, the oral care agents can be about 0.05 to about 1.25 weight percent; specifically, the oral care agents can be about 0.1 to 1 weight percent.

Throat care or throat-soothing ingredients include analgesics, antihistamines, anesthetics, demulcents, mucolytics, expectorants, antitussives, antiseptics, and combinations thereof. In some embodiments, a throat soothing agent such as honey, propolis, aloe vera, glycerin, menthol, or a combination thereof is employed. Throat care agents can be present in a suitable amount depending upon the desired level of care. In some embodiments, the throat care agents are present in an amount of about 0.01 to about 2 weight percent of the chewing gum composition. Within the range of about 0.01 to about 2 weight percent, the throat care agents can be about 0.05 to about 1.25 weight percent; specifically, the throat care agents can be about 0.1 to 1 weight percent

Medicaments can be included in the chewing gum product. Non-limiting illustrative categories and specific examples include antihistamines, decongestants (sympathomimetics), antitussives (cough suppressants), expectorants, anesthetics, analgesics, demulcents, antibacterial agents, antiviral agents, anti-inflammatories, antacids, antifungal agents, chemotherapeutics, diuretics, psychotherapeutic agents, homeopathic agents, anticholinergics, throat-soothing agents, antinauseants, cardiovascular agents, various alkaloids, laxatives, appetite suppressants, ACE-inhibitors, anti-asthmatics, anti-cholesterolemics, anti-depressants, anti-diarrhea preparations, anti-hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants, osteoporosis preparations, oxytocics, parasympatholytics, parasympathomimetics, prostaglandins, respiratory agents, sedatives, smoking cessation aids such as bromocryptine or nicotine, tremor preparations, urinary tract agents, anti-ulcer agents, anti-emetics, hyper- and hypo-glycemic agents, thyroid and anti-thyroid preparations, terine relaxants, erythropoietic drugs, mucolytics, DNA and genetic modifying drugs, and nutritional supplements, including nutraceuticals, micronutrients, vitamins and co-enzymes. The pharmaceutically acceptable salts and prodrugs of the medicaments are also included unless specified otherwise. Some of these medicaments can serve more than one purpose. Combinations of the foregoing types of optional medicaments can be used. Two or more medicaments that have activity against the same or different symptoms can be used together in a combination.

Medicaments for the treatment of a cough, or a cold or flu symptom include elements, compounds or materials, alone or in combination, that have been used for, or have been shown to be useful for, the amelioration of at least one symptom commonly associated with cough, colds, or influenza. It is to be understood that a “medicament for the treatment of a cough, or a cold or flu symptom” includes medicaments that are also useful for the treatment of cold-like or flu-like symptoms arising from other sources, such as allergies, adverse environmental conditions, and the like. Cold, cold-like, flu, and flu-like symptoms as used herein include cough, coryza, nasal congestion, upper respiratory infections, allergic rhinitis, otitis, sinusitis, sneezing, and the discomfort, pain, fever and general malaise associated with colds, flu, allergies, adverse environmental conditions, and the like.

Examples of general categories of medicaments for the treatment of a cough, or a cold or flu symptom include antihistamines, decongestants (sympathomimetics), antitussives (cough suppressants), anti-inflammatories, homeopathic agents, expectorants, anesthetics, demulcents, analgesics, anticholinergics, throat-soothing agents, antibacterial agents, and antiviral agents. Some of these medicaments can serve more than one purpose. The pharmaceutically acceptable salts and prodrugs of the medicaments are also included unless specified otherwise. Two or more medicaments that have activity against the same or different symptoms of colds or coughs can be used together in a combination.

Exemplary antihistamines include azatadine, bromodiphenhydramine, brompheniramine, brompheniramine maleate, carbinoxamine, carbinoxamine maleate, cimetidine, chlorpheniramine, chlorpheniramine maleate, dexchlorpheniramine, diphenhydramine, diphenhydramine hydrochloride, doxylamine, phenindamine, pheniramine, phenyltoloxamine, pyrilamine, promethazine, triprolidine, loratadine, ranitidine, chlorocyclizine, terfenadine, clemastine fumarate, dimenhydrinate, pyrilamine maleate, tripelennamine hydrochloride, tripelennamine citrate, hydroxyzine pamoate, hydroxyzine hydrochloride, cyclizine lactate, cyclizine hydrochloride, meclizine hydrochloride, acrivastine, cetirizine hydrochloride, astemizole, levocabastine hydrochloride, cetirizine, and combinations thereof.

Exemplary decongestants include agents such as levopropoxyphene napsylate, noscapine, carbetapentane, caramiphen, chlophedianol, pseudoephedrine hydrochloride, phenylephrine, phenylpropanolamine, diphenhydramine, glaucine, pholcodine, benzonatate, ephedrine, ephinephrine, levodesoxyephedrine, oxymetazoline, naphazoline, propylhexedrine, xylometazoline, and combinations thereof.

Antitussives help relieve coughing. Examples of antitussives include codeine, dihydrocodeine, hydrocodone and hydromorphone, carbetapentane, caramiphen, hydrocodone bitartrate, chlophedianol, noscapine, dextromethorphan, and combinations thereof.

Expectorants include guaifenesin, aniseed, blood root, coltsfoot, elderflower, golden seal, grindelia, hyssop, lungwort, mullein, senega, thuja, thyme, vervain, glyceryl guaiacolate, terpin hydrate, N-acetylcysteine, bromhexine, ambroxol, domiodol, 3-iodo-1,2-propanediol and wild cherry, ammonium chloride, calcium iodide, iodinated glycerol, potassium guaiacolsulfonate, potassium iodide, sodium citrate, and combinations thereof.

Anaesthetics include etomidate, ketamine, propofol, and benzodiazapines (e.g., chlordiazepoxide, diazepam, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocaine, procaine, proparacaine, ropivacaine, tetracaine, and combinations thereof. Other useful agents can include amobarbital, aprobarbital, butabarbital, butalbital mephobarbital, methohexital, pentobarbital, phenobarbital, secobarbital, thiopental, paral, chloral hydrate, ethchlorvynol, glutethimide, methprylon, ethinamate, meprobamate, and combinations thereof.

Analgesics include opioids such as morphine, mepidine, dentanyl, sufentanil, alfentanil, aspirin, salicylamide, sodium salicylate, acetaminophen, ibuprofen, indomethacine, naproxen, atrin, isocome, midrin, axotal, firinal, phrenilin, ergot and ergot derivatives (wigraine, cafergot, ergostat, ergomar, dihydroergotamine), imitrex, and combinations thereof.

Anticholinergics include homatropine, atropine, scopolamine hydrogen bromide, L-hyoscyamine, L-alkaloids of belladonna, tincture of belladonna alkaloids, homatropine hydrogen bromide, homatropine methylbromide, methscopolamine, anisotropine, anisotropine with phenobarbital, clidinium, glycopyrrolate, hexocyclim, isopropamide, mepenzolate, methantheline, oxyphencyclimine, propantheline, tridihexethyl, dicyclomine, scopolamine, atropine, dicyclomine, flavoxate, ipratropium, oxybutynin, pirenzepine, tiotropium, tolterodine, tropicamide, trimethaphan, atracurium, doxacurium, mivacurium, pancuronium, tubocurarine, vecuronium, suxamethonium chloride, and combinations thereof.

Demulcents include coltsfoot, comfrey, corn silk, couchgrass, flaxseed, irish moss, lungwort, liquorice, mallow, marshmallow, mullein, oatmeal, parsley piert, slippery elm, and combinations thereof.

Antibacterial agents include those within the antibiotic classes of aminoglycosides, cephalosporins, macrolides, penicillins, quinolones, sulfonamides, and tetracyclines. Specific exemplary antibiotic agents include nafcillin, oxacillin, vancomycin, clindamycin, erythromycin, trimethoprim-sulphamethoxazole, rifampin, ciprofloxacin, broad spectrum penicillin, amoxicillin, gentamicin, ceftriazoxone, cefotaxime, chloramphenicol, clavunate, sulbactam, probenecid, doxycycline, spectinomycin, cefixime, penicillin G, minocycline, β-lactamase inhibitors; meziocillin, piperacillin, aztreonam, norfloxacin, trimethoprim, ceftazidime, dapsone, neomycin, azithromycin, clarithromycin, amoxicillin, ciprofloxacin, and vancomycin.

Antiviral agents specifically or generally modulate the biological activity of viruses such as picornavirus, influenza virus, herpes viruses, herpes simplex, herpes zoster, enteroviruses, varicella and rhinovirus, which are associated with the common cold. Exemplary antiviral agents include acyclovir, trifluridine, idoxorudine, foscarnet, ganciclovir, zidovudine, dideoxycytosine, dideoxyinosine, dipyridamole, stavudine, cidofovir, famciclovir, valaciclovir, valganciclovir, acyclovir, didanosine, zalcitabine, rifimantadine, saquinavir, indinavir, ritonavir, ribavarin, nelfinavir, adefovir, nevirapine, delavirdine, efavirenz, abacavir, amantadine, emtricitabine, entecavir, tenofovir, zanamivir, oseltamivir, ICI-130,685, impulsin, pleconaril, penciclovir, vidarabine, cytokines, and combinations thereof.

Anti-inflammatories include salicylic acid derivatives including aspirin, paraminophenol derivatives including acetaminophen, indole and indene acetic acids including indomethacin, sulindac and etodalac, heteroaryl acetic acids including tolmetin diclofenac and ketorolac, aryl propionic acid derivatives including ibuprofen, naproxen, ketoprofen, fenopren, ketorlac, carprofen, oxaprozine, anthranilic acids including mefenamic acid, meclofenamic acid, and enolic acids including piroxicam, tenoxicam, phenylbutazone and oxyphenthatrazone.

Antacids include cimetidine, ranitidine, nizatidine, famotidine, omeprazole, bismuth antacids, metronidazole antacids, tetracycline antacids, clathromycin antacids, hydroxides of aluminum, magnesium, sodium bicarbonates, calcium bicarbonate and other carbonates, silicates, phosphates, and combinations thereof.

Antifungal agents include, for example, ketoconazole, fluconazole, nystatin, itraconazole, clomitrazole, natamycin, econazole, isoconazole, oxiconazole, thiabendazole, tiaconazole, voriconazole, terbinafine, amorolfine, micfungin, amphotericin B, and combinations thereof.

Chemotherapeutics agents include cisplatin (CDDP), procarbazine, mechlorethamine, cyclophosphamide, camptothecin, ifosfamide, melphalan, chlorambucil, bisulfan, nitrourea, dactinomycin, daunorubicin, doxorubicin, bleomycin, plicomycin, mitomycin, etoposide (VP16), tamoxifen, taxol, transplatinum, 5-fluorouracil, vincristin, vinblastin and methotrexate and analogs or derivative variants thereof, and combinations thereof.

Diuretics include but are not limited to acetazolamide, dichlorphenamide, methazolamide, furosemide, bumetamide, ethacrynic acid torseimde, azosemide, muzolimine, piretanide, tripamide, bendroflumethiazide, benzthiazide, chlorothiazide, hydrochlorothiazide, hydroflumethiazide, methylclothiazide, polythiazide, trichloromethiazide, indapamide, metolazone, quinethazone, amiloride, triamterene, spironolactone, canrenone, potassium canrenoate, and combinations thereof.

Psychotherapeutic agents include thorazine, serentil, mellaril, millazine, tindal, permitil, prolixin, trilafon, stelazine, suprazine, taractan, navan, clozaril, haldol, halperon, loxitane, moban, orap, risperdal, alprazolam, chlordiazepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, welibutrin, serzone, desyrel, nardil, parnate, eldepryl, and combinations thereof.

Appetite suppressants include benzphetamine, diethylpropion, mazindol, phendimetrazine, phentermine, hoodia, ephedra, and caffeine. Additional appetite suppressant are commercially under the following trade names: Adipex, Adipost, Bontril PDM, Bontril Slow Release, Didrex, Fastin, Ionamin, Mazanor, Melfiat, Obenix, Phendiet, Phendiet-105, Phentercot, Phentride, Plegine, Prelu-2, Pro-Fast, PT 105, Sanorex, Tenuate, Sanorex, Tenuate, Tenuate Dospan, Tepanil Ten-Tab, Teramine, Zantryl and combinations thereof.

Nutraceuticals and micronutrients include herbs and botanicals such as aloe, bilberry, bloodroot, calendula, capsicum, chamomile, cat's claw, echinacea, garlic, ginger, ginko, goldenseal, various ginseng, green tea, golden seal, guarana, kava kava, lutein, nettle, passionflower, rosemary, saw palmetto, St. John's wort, thyme, valerian, and combinations thereof. Also included are mineral supplements such as calcium, copper, iodine, iron, magnesium, manganese, molybdenum, phosphorous, zinc, selenium, and combinations thereof. Other nutraceuticals that can be added include fructo-oligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Vitamins and co-enzymes include water or fat-soluble vitamins such as thiamin, riboflavin, nicotinic acid, pyridoxine, pantothenic acid, biotin, folic acid, flavin, choline, inositol and paraminobenzoic acid, carnitine, vitamin C, vitamin D and its analogs, vitamin A and the carotenoids, retinoic acid, vitamin E, vitamin K, vitamin B₆, vitamin B₁₂, and combinations thereof. Combinations comprising at least one of the foregoing nutraceuticals can be used.

Specific optional, additional medicaments that can be used include caffeine, cimetidine, ranitidine, famotidine, omeprazole, dyclonine, nicotine, and combinations thereof.

The medicaments can be present in a suitable amount depending upon the suitable level of dosage for the desired purpose. In some embodiments, the medicaments are present in an amount of about 0.01 to about 2 weight percent of the chewing gum composition. Within the range of about 0.01 to about 2 weight percent, the medicaments can be about 0.05 to about 1.25 weight percent; specifically, the medicaments can be about 0.1 to 1 weight percent.

Anti-oxidants include natural and artificial anti-oxidants like beta-carotenes, acidulants e.g. Vitamin C, propylgallate, butyl hydroxyanisole, butylated hydroxytoluene, Vitamin E, Carnosic acid, Rosmanol, rosmaridiphenol, and the likes. The anti-oxidants can be present in a suitable amount depending upon the desired purpose. In some embodiments, the anti-oxidants are present in an amount of about 0.01 to about 2 weight percent of the chewing gum composition. Within the range of about 0.01 to about 2 weight percent, the anti-oxidants can be about 0.05 to about 1.25 weight percent; specifically, the anti-oxidants can be about 0.1 to 1 weight percent.

Preservatives include any natural and synthetic preservatives that improve shelf life of a chewing gum product. Suitable preservatives include propanoic acid, benzoic acid, and sorbic acid.

Additional bulking agents (carriers, extenders) suitable for use include sweetening agents such as monosaccharides, disaccharides, polysaccharides, sugar alcohols, polydextrose, maltodextrins, and combinations thereof; and minerals, such as calcium carbonate, talc, titanium dioxide, dicalcium phosphate, silica, and combinations thereof. Bulking agents can be used in amounts up to about 90 weight percent of the chewing gum composition, specifically about 40 to about 70 weight percent of the chewing gum composition, more specifically about 50 to about 65 weight percent of the chewing gum composition.

Suitable emulsifiers include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glyceryl dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, the poly(oxyethylene)sorbitan fatty acid esters sold under the trade name TWEEN, the sorbitan fatty acid esters sold under the trade name SPAN, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, and combinations comprising at least one of the foregoing.

Suitable thickening agents include cellulose ethers (e.g., hydroxyethylcellulose, hydroxypropylmethylcellulose, or hydroxypropylcellulose), methylcellulose, carboxymethylcellulose, and combinations thereof. Additional polymers useful as thickeners include the acrylic acid polymers and copolymer sold under the trade name CARBOMER; poly(vinyl pyrrolidone); poly(vinyl alcohol); sodium alginate; polyethylene glycol; natural gums like xanthan gum, tragacantha, guar gum, acacia gum, arabic gum; water-dispersible polyacrylates like poly(acrylic acid); methyl methacrylate copolymers; carboxyvinyl copolymers; and combinations thereof.

The relative amounts of each of the components of the chewing gum composition will depend on the identity of the component, as well as the desired flavor, and are readily determined by one of ordinary skill in the art.

The gum compositions of the disclosed herein can be coated or uncoated, and be in the form of slabs, sticks, pellets, balls, and the like. The composition of the different forms of the gum compositions will be similar but can vary with regard to the ratio of the ingredients. For example, coated gum compositions can contain a lower percentage of softeners. Pellets and balls can have a chewing gum core, which has been coated with either a sugar solution or a sugarless solution to create the hard shell. Slabs and sticks are usually formulated to be softer in texture than the chewing gum core. In some cases, a hydroxy fatty acid salt or other surfactant actives can have a softening effect on the gum base. In order to adjust for any potential undesirable softening effect that the surfactant actives can have on the gum base, it can be beneficial to formulate a slab or stick gum having a firmer texture than usual (i.e., use less conventional softener than is typically employed).

Center-filled gum is another common gum form. The gum portion has a similar composition and mode of manufacture to that described above. However, the center-fill is typically an aqueous liquid or gel, which is injected into the center of the gum during processing. The encapsulated sweetener composition can, optionally, be incorporated into the center-fill during manufacture of the fill, incorporated directly into the chewing gum portion of the total gum composition, or incorporated into both the center-fill and the chewing gum portion. The center-filled gum can also be optionally coated and can be prepared in various forms, such as in the form of a lollipop.

This disclosure further comprises methods of preparing an encapsulated sweetener composition and a chewing gum containing the same. Some embodiments include a method for preparing the gum compositions, including both chewing gum and bubble gum compositions. These chewing gum compositions can be prepared using any standard techniques and equipment known to those skilled in the art. The apparatus useful in accordance with some embodiments includes mixing and heating apparatus that are well known in the chewing gum manufacturing arts, and therefore the selection of the specific apparatus will be apparent to the artisan.

In one embodiment, a method of preparing an encapsulated sweetener composition comprises melt blending a poly(vinyl acetate), a fatty acid salt, a filler and a sweetener to form the encapsulated sweetener composition. In some embodiments the sweetener used to form the encapsulated sweetener composition is a solid at 25° C. and one atmosphere and has a particle size as previously described herein. In some embodiments, melt blending the poly(vinyl acetate), the fatty acid salt, the filler and the sweetener is conducted at a temperature of about 80 to about 120 degrees Celsius, more specifically at a temperature of about 90 to about 110 degrees Celsius. In a preferred embodiment, melt blending the poly(vinyl acetate), the fatty acid salt, the filler and the sweetener includes the steps of blending the fatty acid salt with the melted poly(vinyl acetate), and then blending the filler and the sweetener with the melt-blended poly(vinyl acetate) and fatty acid salt to form the encapsulated sweetener composition.

Once the encapsulated sweetener composition is formed it can be cooled and ground to form particles having a number average particle size of about 50 to about 800 micrometers, specifically of about 100 to about 600 micrometers, more specifically of about 250 about 420 micrometers. In other embodiments, the encapsulated sweetener composition can be processed into particles by grinding, sieving, screening, cutting, crushing, compressing, milling, or the like. Once the encapsulated sweetener composition is processed to the desired particle size, it can be stored in a cool dry place, such as in an airtight container at low humidity and a temperature less than about 35° C.

The encapsulated sweetener composition can be further incorporated into a chewing gum composition by melt blending a gum base and the encapsulated sweetener composition to form the chewing gum composition. A preferred embodiment includes blending the gum base, a sweetener, and the encapsulated sweetener composition to form the chewing gum composition. In another preferred embodiment blending the gum base, the sweetener, and the encapsulated sweetener composition further includes blending the gum base, the sweetener, and the encapsulated sweetener composition with an unencapsulated food-grade acid.

In addition, melt blending the poly(vinyl acetate), the fatty acid salt, the filler, and the sweetener includes melt blending with a mixing energy of about 70 to about 350 kilojoules per kilogram of encapsulated sweetener composition. In some embodiments, the mixing energy is about 100 to about 300 kilojoules per kilogram, specifically about 150 to about 250 kilojoules per kilogram. Mixing energy for melt blending is calculated by dividing the energy consumed to drive the melt mixing elements (e.g., the screws of a twin-screw extruder) by the mass of melt processed. For example, if 100 kilojoules of energy are required to drive the screws of a twin-screw extruder during the melt blending of 1 kilogram of encapsulated sweetener composition, then the mixing energy is 100 kilojoules/1 kilogram=100 kilojoules/kilogram.

In one exemplary process, a gum base is heated to a temperature sufficiently high to soften the gum base without adversely affecting the physical and chemical make up of the gum base, which will vary depending upon the composition of the gum base used, and is readily determined by those skilled in the art without undue experimentation. For example, the gum base can be melted to about 60° C. to about 160° C., or melted to about 150° C. to about 175° C., for a period of time sufficient to render the base molten, e.g., about thirty minutes, just prior to being admixed incrementally with the remaining ingredients of the base such as the plasticizer, fillers, the bulking agent or sweeteners, the softener and coloring agents to plasticize the blend as well as to modulate the hardness, viscoelasticity and formability of the base, and the flavor enhancing composition (as a concentrate with other additives or separately). Mixing is continued until a uniform mixture of the gum composition is obtained. The resulting chewing gum composition is allowed to cool. Thereafter the gum composition mixture can be sized and formed into desirable gum shapes, i.e., stick, slab, pellet, ball, or the like. The sized chewing gum can be conditioned for about one day to about one week prior to packaging the chewing gum.

In one preferred embodiment, the method of preparing a chewing gum composition includes melt blending a poly(vinyl acetate), a fatty acid salt, a filler and a sweetener to form an encapsulated sweetener composition. Then melt blending a gum base and the encapsulated sweetener composition to form a chewing gum composition, wherein the encapsulated sweetener composition comprises the fatty acid salt in an amount of about 2 to about 20 weight percent, the filler in an amount of about 2 to about 20 weight percent, the sweetener, and the poly(vinyl acetate), based on the total weight of the encapsulated sweetener composition. In some embodiments, the fatty acid salt comprises calcium stearate or magnesium stearate; the filler comprises talc; the sweetener comprises lo han guo, sucralose, monatin, rebaudioside A, steviosides, acesulfame potassium, aspartame, aspartame-acesulfame, or a combination thereof; the sweetener has a number average particle size of about 50 to about 100 micrometers prior to said melt blending the poly(vinyl acetate), the fatty acid salt, the filler, and the sweetener; the encapsulated sweetener composition comprises the fatty acid salt and the sweetener in a weight ratio of about 1:0.25 to about 1:25, the fatty acid salt and the poly(vinyl acetate) in a weight ratio of about 1:1.75 to about 1:45, the sweetener and the poly(vinyl acetate) in a weight ratio of about 1:0.7 to about 1:18; and wherein the chewing gum composition comprises about 0.25 to about 11 weight percent of the encapsulated sweetener composition. In some embodiments, the method further includes melt blending the poly(vinyl acetate), the fatty acid salt, the filler, and the sweetener at a temperature of about 90 to about 120 degrees Celsius, grinding the encapsulated sweetener composition to form particles having a number average particle size less than or equal to 420 micrometers, and blending the gum base and the encapsulated sweetener composition with an unencapsulated sweetener, an unencapsulated food-grade acid, or a combination thereof.

In some embodiments, gum pieces can be coated with an aqueous coating composition, which can be applied by any method known in the art. The coating composition can be present in an amount of about 10 to about 50 weight percent of the total chewing gum piece. Within the rage of about 10 to about 50 weight percent, the coating composition amount can be about 20 to about 40 weight percent, specifically about 25 to 35 weight percent of the total chewing gum piece.

The outer coating can be hard or crunchy. In some embodiments, the outer coating includes sorbitol, maltitol, xylitol, isomalt, or another crystallizable polyol; sucrose can also be used. Flavorants can also be added to yield unique product characteristics.

The coating, if present, can include several opaque layers, such that the chewing gum composition is not visible through the coating itself, which can optionally be covered with a further one or more transparent layers for aesthetic, textural and protective purposes. The outer coating can also contain small amounts of water and gum arabic. The coating can be further coated with wax. The coating can be applied in a conventional manner by successive applications of a coating solution, with drying in between each coat. As the coating dries it usually becomes opaque and is usually white, though other colorants can be added. A polyol coating can be further coated with wax. The coating can further include colored flakes or speckles.

If the composition comprises a coating, it is possible that one or more of the above-mentioned active ingredients can be dispersed throughout the coating. This may be preferred if one or more of the active ingredients is incompatible in a single phase composition with another of the actives.

The coating can be formulated to assist with increasing the thermal stability of the gum piece and preventing leaking of a liquid fill if the gum product is a center-filled gum. In some embodiments, the coating can include a gelatin composition. The gelatin composition can be added as a 40 weight percent solution and can be present in the coating composition about 5 to about 10 weight percent of the coating composition, and more specifically about 7 to about 8 weight percent of the coating solution. The gel strength of the gelatin can be about 130 bloom to about 250 bloom.

Additives, such as physiological coolants, throat-soothing agents, spices, warming agents, oral care agents, medicaments, vitamins, caffeine, and conventional additives can be included in any or all portions of the chewing gum composition. Such components can be used in amounts sufficient to achieve their intended effects.

The foregoing and other embodiments are further illustrated by the following examples, which are not intended to limit the effective scope of the claims. All parts and percentages in the examples and throughout the specification and claims are by weight of the final composition unless otherwise specified.

### Example 1 and Comparative Example 1

Example 1 illustrates the preparation of an encapsulated sweetener composition comprising texture modifiers such as magnesium stearate and other texture modifiers, and fillers such as talc and other fillers. Compositions are summarized in Table 1, where component amounts are expressed in weight percent based on the total weight of the encapsulated sweetener composition. The poly(vinyl acetate) had a weight average molecular weight of about 100,000 and was obtained as Vinnapas® B100 from Wacker Biosolutions. The lo han guo was obtained as PureLo® from BioVittoria Ltd. The sweetener, lo han guo, was obtained in powder form having a number average particle size of about 38 micrometers. In Example 1 of Table 1, the magnesium stearate was obtained as HyQual® from Mallinckrodt Chemicals, Inc., and talc was obtained as Imperial 700 FCC (Talc) from Luzenac America. In Comparative Example 1 of Table 1, the glycerol monostearate is obtained as Aldo® MS from Lonza Group Ltd., and the hydrogenated oil is a blend of hydrogenated cottonseed oil and hydrogenated palm oil, the hydrogenated oil blend having a melting point of about 71° C., obtained as Hydrogenated Vegetable Oil from Stratas Foods. The extruder was a Brabender conical twin-screw extruder having a 43.2 millimeter (feed end) to 29 millimeter (discharge end) internal diameter and a barrel length of 36 centimeters, operated at a barrel temperature of 90° C.

To prepare the encapsulated sweetener compositions, the poly(vinyl acetate) was melt blended with any texture modifier and any filler, then the sweetener was added. The extrudate was cooled, then ground and sieved to a number average particle size less than 420 micrometers. The powdered encapsulated sweetener composition was stored in an air-tight container at low humidity and a temperature less than 35° C. prior to use to form gum compositions.

TABLE 1

| | |
|---|---|
| Ex. 1 | C. Ex. 1 |

COMPOSITIONS

| | | |
|---|---|---|
| Poly(vinyl acetate)* | 56.00 | 65.00 |
| Texture Modifier (Magnesium Stearate) | 12.00 | 0.00 |
| Talc | 2.00 | 0.00 |
| Lo Han Guo | 30.00 | 30.00 |
| Hydrogenated oil | 0.00 | 3.75 |
| Glycerol monostearate | 0.00 | 1.25 |

*Average molecular weight = 100,000

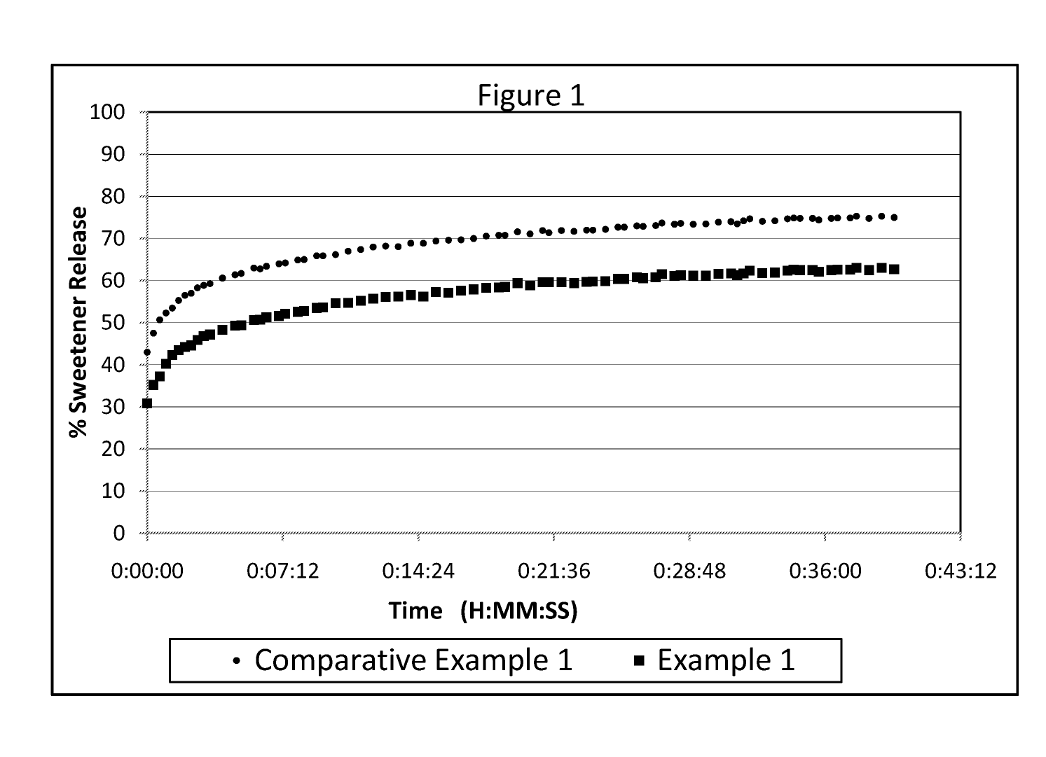

FIG. 1 is a plot showing the percent of sweetener released (%) versus time (hours: minutes: seconds) for the dissolution profiles of the sweetener encapsulations of Example 1 and Comparative Example 1. The dissolution profile for Comparative Example 1 was not obtained through experimentation. The data for Comparative Example 1 was calculated based upon the release profiles of other actives encapsulated in a combination of poly(vinyl acetate), glycerol monostearate, and hydrogenated oil and extrapolated from the dissolution profile of Example 1, which was obtained through experimentation.

### Examples 2A, 2B and 3 and Comparative Examples 2A, 2B and 3

Examples 2A, 2B and 3 illustrate the preparation of encapsulated sweetener compositions comprising processing aids/texture modifiers such as magnesium stearate and calcium stearate. These Examples illustrate the advantages of using a processing aid/texture modifier in combination with a poly(vinyl)acetate having a high molecular weight. Examples 2A, 2A and 3 and Comparative Examples 2A, 2B and 3 are summarized in Table 2, where component amounts are expressed in weight percent based on the total weight of the encapsulated sweetener composition. The high molecular weight poly(vinyl acetate) had a weight average molecular weight of about 100,000 and was obtained as Vinnapas® B 100 from Wacker Biosolutions. The low molecular weight poly(vinyl acetate) had a weight average molecular weight of about 35,000 and was obtained as Vinnapas® B 17 from Wacker Biosolutions. The sweetener, aspartame-acesulfame, was obtained as Twinsweet® from the The Nutrasweet Company, and the sucralose was obtained as Sucralose from Tate & Lyle. The sweeteners, aspartame-acesulfame and sucralose, were obtained in powder form having a number average particle size of about 81 and about 10 micrometers, respectively. In Examples 2A and 3 of Table 2, the magnesium stearate was obtained as Hyqual® from Mallinckrodt Chemicals, Inc. In Example 2B of Table 2, the calcium stearate was obtained as Kosher Passover Food Grade Hyqual® from Mallinckrodt Chemicals, Inc. In Comparative Example 2A of Table 2, the low molecular weight poly(vinyl acetate) had a weight average molecular weight of about 35,000 and was obtained as Vinnapas B 17 from Wacker Biosolutions. The extruder was a Brabender conical twin-screw extruder having a 43.2 millimeter (feed end) to 29 millimeter (discharge end) internal diameter and a barrel length of 36 centimeters.

To prepare the encapsulated sweetener compositions, the poly(vinyl acetate) was melt blended with and without any texture modifier, then the sweetener was added. The extrudate was cooled, then ground and sieved to a number average particle size less than 420 micrometers. The powdered encapsulated sweetener composition was stored in an air-tight container at low humidity and a temperature less than 35° C. prior to use to form gum compositions,

TABLE 2

| | | | | | |
|---|---|---|---|---|---|
| C. Ex. 2A | C Ex. 2B | Ex. 2A | Ex. 2B | C. Ex. 3 | Ex. 3 |

COMPOSITIONS

| | | | | | | |
|---|---|---|---|---|---|---|
| Poly(vinyl acetate)* High MW | 0.00 | 77.00 | 75.00 | 70.00 | 65.00 | 65.00 |
| Poly(vinyl acetate)** Low MW | 77.00 | 0.00 | 0.00 | 0.00 | 0.00 | 0.00 |
| Texture Modifier (Magnesium | 0.00 | 0.00 | 5.00 | 0.00 | 0.00 | 5.00 |
| Stearate) | | | | | | |
| Texture Modifier (Calcium | 0.00 | 0.00 | 0.00 | 10.00 | 0.00 | 0.00 |
| Stearate) | | | | | | |
| Aspartame-Acesulfame | 0.00 | 0.00 | 0.00 | 0.00 | 30.00 | 30.00 |
| Sucralose | 20.00 | 20.00 | 20.00 | 20.00 | 0.00 | 0.00 |
| Hydrogenated oil | 0.00 | 0.00 | 0.00 | 0.00 | 3.75 | 0.00 |
| Glycerol monostearate | 3.00 | 3.00 | 0.00 | 0.00 | 1.25 | 0.00 |
| Temperature (Celsius)*** | 75 | 90 | 80 | 85 | 110 | 110 |
| Extrudate Color | Acceptable | Not | Acceptable | Acceptable | Not | Acceptable |
| Acceptable = stable | (white) | Acceptable | (white) | (white) | Acceptable | (white) |
| Not Acceptable = unstable | | (dark brown) | | | (dark orange) | |

*Number average molecular weight = 100,000
**Number average molecular weight = 35,000
***Barrel Temperature of a Brabender-Twinscrew extruder

Examples 2A, 2B and 3 illustrate the increase in the process stability provided by encapsulating the sweetener with a combination of high molecular weight poly(vinyl)acetate and any texture modifier. The results, presented in Table 2, show that when either of sucralose or aspartame-acesulfame are encapsulated in a combination of a poly(vinyl)acetate having a number average molecular weight of about 100,000 and magnesium stearate via a high temperature extrusion process, the resultant encapsulated sweetener composition remained white in color. The absence of darkening of the extrudate indicates that the sweetener has remained stable during the extrusion process and was resistant to thermal degradation during processing. Thus, the addition of a texture modifier, such as magnesium or calcium stearate, results in the ability to produce a sweetener encapsulated in high molecular weight poly(vinyl acetate) via a high temperature extrusion process. This results in a stable sweetener composition, which is as stable as a sweetener encapsulated in low molecular weight poly(vinyl)acetate at the lower extrusion temperature of 80 or 85 degrees Celsius, as shown in Examples 2A and 2B. Example 3, which has aspartame-acesulfame encapsulated in a poly(vinyl)acetate having a number average molecular weight of about 100,000 with magnesium stearate using a high temperature extrusion process shows stability even at a relatively high extrusion temperature (110 degrees C.) In contrast, Comparative Examples 2B and 3, which are respectively sucralose and aspartame-acesulfame encapsulated in a poly(vinyl)acetate having a number average molecular weight of about 100,000 without any magnesium stearate using a high temperature extrusion process show the undesirable darkening of the resultant encapsulated sweetener composition indicated that the sweeteners were unstable and thermally degraded when extruded at a temperature of 110 degrees Celsius.

When encapsulating aspartame-acesulfame in poly(vinyl acetate), the encapsulation matrix turns yellow during processing. The acidic nature of aspartame-acesulfame catalyzes a thermal decomposition of the poly(vinyl acetate). This results in the release of acetic acid and leads to the formation of conjugated regions within the polymer backbone. The conjugation of the polymer backbone results in the yellow color.

In addition, aspartame-acesulfame is acidic compared to other high-intensity sweeteners such as aspartame, acesulfame K, and sucralose. This is illustrated by forming two separate solutions by dissolving aspartame-acesulfame in water and by dissolving free aspartame in water and then measuring the pH of the resulting solutions. The pH of the aspartame-acesulfame solution is about 2.5 in contrast to the aspartame solution which has a pH of about 6.

The thermal degradation of poly(vinyl acetate) begins at about 140 to about 160 degrees Celsius. However in the presence of an acid catalyst (e.g., aspartame-acesulfame) this decomposition can occur at lower temperatures (i.e., at extrusion temperatures). The poly(vinyl acetate) decomposition process proceeds by the incremental loss of acetic acid from the ends of the polymer chains resulting in the partial formation of an unsaturated polymer backbone on the poly(vinyl acetate), resulting in a color change ranging yellowish to brown color. Since the by-product of the decomposition is an acid (i.e., acetic acid), the decomposition can proceed autocatalytically. An example of the decomposition reaction is shown below:

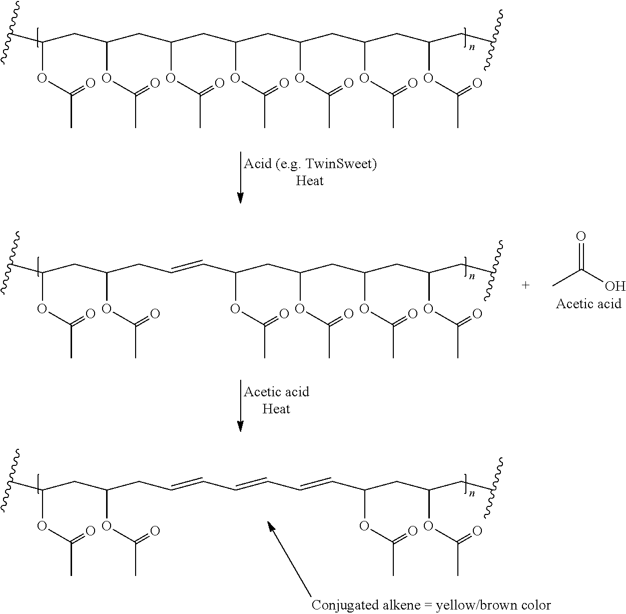

Stearates function in two ways to prevent thermal decomposition of the encapsulating material. First, stearates act as processing aids during extrusion, wherein the stearates lower the polymer melt-viscosity and provide lubrication for the polymer melt. This allows the extrusion process to be run at lower temperatures. In certain instances this lower temperature is all that is needed to prevent thermal decomposition from starting. Second, another function of stearates is to act as acid scavengers, thereby preventing the thermal decomposition from proceeding autocatalytically once it begins by neutralizing the acetic acid as it is formed. The stearates also serve to neutralize other acidic byproducts, such as various acids that can be present or formed when using other sweeteners.

### Example 4 and Comparative Example 4

These examples illustrate the preparation of chewing gums using encapsulated sweetener compositions. The Example 4 chewing gum composition incorporates the inventive encapsulated sweetener composition of Example 1. The Comparative Example 4 chewing gum composition incorporates the comparative encapsulated sweetener composition of Comparative Example 1. The chewing gum compositions are summarized in Table 3, wherein the component amounts are expressed in weight percent based on the total weight of the chewing gum composition.

To prepare the compositions, the gum base is melted in a mixer at 98 degrees Celsius. The remaining ingredients shown in Table 3 and the encapsulated sweetener composition are then added to the mixer containing the molten gum base and combined to disperse the ingredients. The resultant chewing gum mixture is cooled and then processed into the desired chewing gum shape. The chewing gum is conditioned at 14 degrees Celsius and at 25 percent relative humidity for about one week prior to packaging the chewing gum.

TABLE 3

| | |
|---|---|
| Ex. 4 | C. Ex. 4 |

COMPOSITIONS

| | | |
|---|---|---|
| Gum Base | 42.71 | 42.71 |
| Sorbitol | 37.42 | 37.42 |
| Mannitol | 9.00 | 9.00 |
| Flavor (Fruit flavor) | 3.67 | 3.67 |
| Glycerin | 1.50 | 1.50 |
| Lecithin | 0.20 | 0.20 |
| Encapsulated lo han guo | 4.50 | 0.00 |
| (Example 1) | | |
| Encapsulated lo han guo | 0.00 | 4.50 |
| (Comparative Example 1) | | |
| Citric Acid | 0.50 | 0.50 |
| Malic Acid | 0.50 | 0.50 |
| Total | 100.00 | 100.00 |

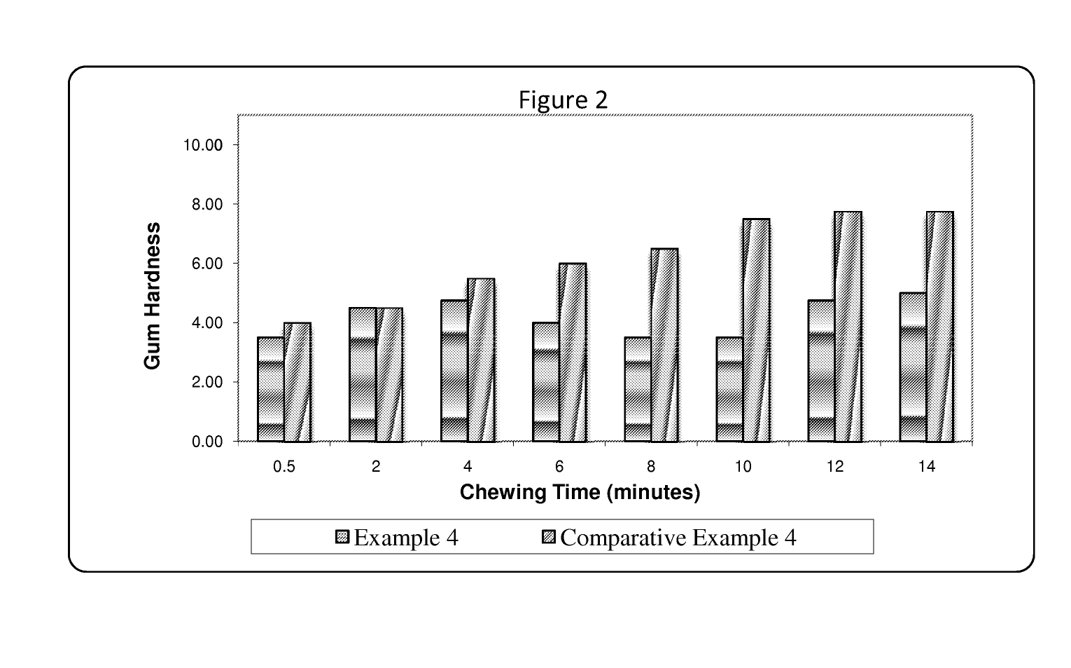

A sensory evaluation test panel evaluated the chewing gums of Example 4 and Comparative Example 4 to determine hardness and sweetness as a function of chewing time. FIG. 2 is a bar chart showing the gum hardness as a function of chewing time (minutes) for the chewing gums of (a) Comparative Example 4, which is a chewing gum containing sweetener encapsulated with poly(vinyl acetate) alone, and (b) Example 4, which is a chewing gum containing sweetener encapsulated with poly(vinyl acetate), fatty acid salt and a filler). FIG. 2 shows that a chewing gum containing an encapsulated sweetener composition having a fatty acid salt incorporated therein exhibits a soft texture from about 4 to about 6 minutes onward as compared to a chewing gum having an encapsulated sweetener that does not have a fatty acid salt incorporated therein.

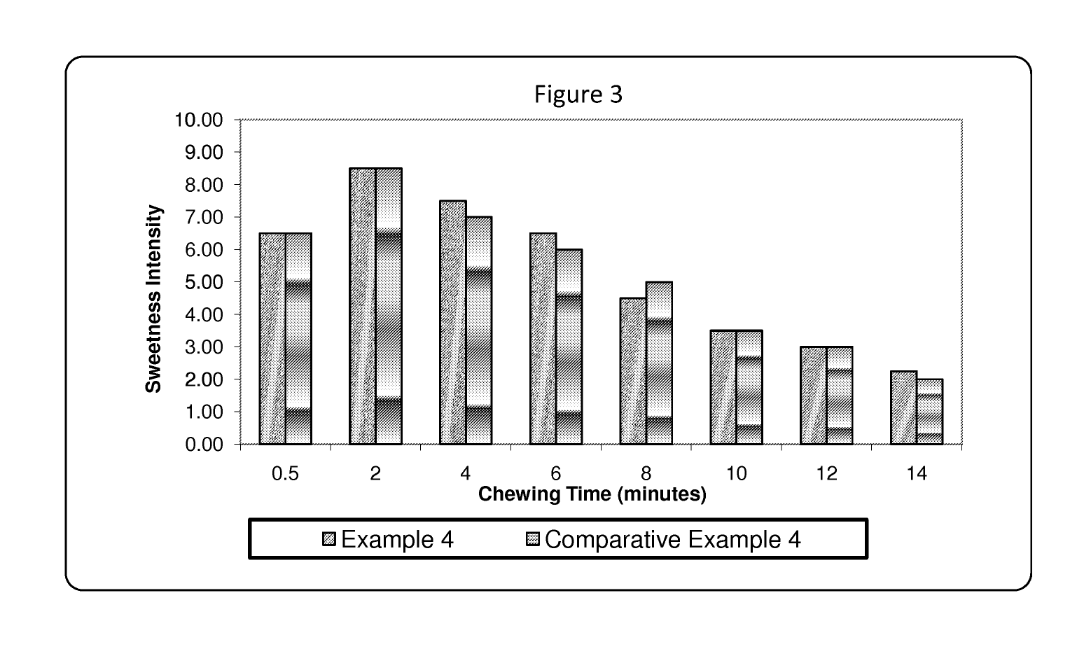

FIG. 3 is a bar chart showing the gum sweetness as a function of chewing time (minutes) for the chewing gums of (a) Comparative Example 4, which is a chewing gum containing sweetener encapsulated with poly(vinyl acetate) alone, and (b) Example 4, which is a chewing gum containing sweetener encapsulated with poly(vinyl acetate), fatty acid salt and a filler). FIG. 3 shows that a chewing gum containing an encapsulated sweetener composition having a fatty acid salt incorporated therein exhibits a minimal change in the release rate of the sweetener as compared to a chewing gum having an encapsulated sweetener that does not have a fatty acid salt incorporated therein. This results in a chewing gum having an improved soft texture without altering or changing the sweetness intensity as experienced by the end-user during mastication.

This written description uses examples to disclose the invention, including the best mode, and also to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. An encapsulated sweetener composition comprising:
an encapsulating material comprising
a poly(vinyl acetate),
about 2 to about 20 weight percent of a fatty acid salt selected from the group consisting of alkali metal fatty acid salts, alkaline earth metal fatty acid salts, and combinations thereof, and
about 2 to about 20 weight percent of a filler; and
a sweetener,
wherein the encapsulating material at least partially encapsulates the sweetener and wherein all weight percents are based on the total weight of the encapsulated sweetener composition.

2. The encapsulated sweetener composition of claim 1, wherein the poly(vinyl acetate) has a weight average molecular weight of at least 75,000 atomic mass units.

3. The encapsulated sweetener composition of claim 1, wherein the fatty acid salt is selected from the group consisting of alkali metal stearates, alkaline earth metal stearates, alkali metal ricinoleates, and combinations thereof.

4. The encapsulated sweetener composition of claim 1, wherein the fatty acid salt comprises an alkaline earth metal stearate.

5. The encapsulated sweetener composition of any of claims 1-3 claim 1, wherein the fatty acid salt is selected from the group consisting of a sodium salt of a C₁₆-C₃₆ aliphatic carboxylic acid, a potassium salt of a C₁₆-C₃₆ aliphatic carboxylic acid, a calcium salt of a C₁₆-C₃₆ aliphatic carboxylic acid, a magnesium salt of a C₁₆-C₃₆ aliphatic carboxylic acid, and combinations thereof.

6. The encapsulated sweetener composition of claim 1, wherein the fatty acid salt comprises sodium stearate, potassium stearate, magnesium stearate, calcium stearate, sodium ricinoleate, and combinations thereof.

7. The encapsulated sweetener composition of claim 1, wherein the fatty acid salt comprises magnesium stearate, calcium stearate, and combinations thereof.

8. The encapsulated sweetener composition of claim 1, wherein the sweetener is selected from the group consisting of lo han guo, sucralose, monatin, rebaudioside A, steviosides, acesulfame potassium, aspartame, aspartame-acesulfame, and combinations thereof.

9. The encapsulated sweetener composition of claim 1, wherein the sweetener is selected from the group consisting of lo han guo, sucralose, monatin, aspartame-acesulfame, and combinations thereof.

10. The encapsulated sweetener composition of claim 1, wherein the filler is selected from the group consisting of talc, calcium carbonate, dicalcium phosphate, silica, and combinations thereof.

11. The encapsulated sweetener composition of claim 1, wherein the filler comprises talc.

12. The encapsulated sweetener composition of claim 1, comprising about 35 to about 90 weight percent poly(vinyl)acetate.

13. The encapsulated sweetener composition of claim 1, comprising about 5 to about 50 weight percent sweetener.

14. The encapsulated sweetener composition of claim 1, wherein the weight ratio of the fatty acid salt to the sweetener in the encapsulated sweetener composition is about 1:0.25 to about 1:25.

15. The encapsulated sweetener composition of claim 1, wherein the weight ratio of the fatty acid salt to the poly(vinyl acetate) in the encapsulated sweetener composition is about 1:1.75 to about 1:45.

16. The encapsulated sweetener composition of claim 1, wherein the weight ratio of the sweetener to the poly(vinyl acetate) in the encapsulated sweetener composition is about 1:0.7 to about 1:18.

17. The encapsulated sweetener composition of claim 1, wherein the encapsulated sweetener composition has a number average particle of about 50 to about 800 micrometers.

18. The encapsulated sweetener composition of claim 1,
wherein the fatty acid salt comprises magnesium stearate, calcium stearate, or combinations thereof;
wherein the filler comprises talc;
wherein the sweetener is selected from the group consisting of lo han guo, sucralose, monatin, rebaudioside A, steviosides, acesulfame potassium, aspartame, aspartame-acesulfame, and combinations thereof;
wherein the weight ratio of the fatty acid salt to the sweetener in the encapsulated sweetener composition is about 1:0.25 to about 1:25;
wherein the weight ratio of the fatty acid salt to the poly(vinyl acetate) in the encapsulated sweetener composition is about 1:1.75 to about 1:45;
wherein the weight ratio of the sweetener to the poly(vinyl acetate) in the encapsulated sweetener composition is about 1:0.7 to about 1:18; and
wherein the encapsulated sweetener composition has a number average particle size less than or equal to about 420 micrometers.

19. A chewing gum composition comprising:
a gum base,
an unencapsulated sweetener, and
an encapsulated sweetener composition comprising
an encapsulating material comprising
a poly(vinyl acetate),
about 2 to about 20 weight percent of a fatty acid salt selected from the group consisting of alkali metal fatty acid salts, alkaline earth metal fatty acid salts, and combinations thereof, based on the total weight of the encapsulated sweetener composition, and
about 2 to about 20 weight percent of a filler; based on the total weight of the encapsulated sweetener composition and
a sweetener,
wherein the encapsulating material at least partially encapsulates the sweetener composition.

20-38. (canceled)

39. The chewing gum composition of claim 19, wherein a bolus produced by chewing the chewing gum composition for 10 minutes is no harder than a corresponding bolus produced after 10 minutes of chewing a corresponding chewing gum composition lacking the encapsulated sweetener composition.

40. A method of preparing a chewing gum composition of claim 19 comprising:
melt blending
a poly(vinyl acetate),
about 2 to about 20 weight percent of a fatty acid salt selected from the group consisting of alkali metal fatty acid salts, alkaline earth metal fatty acid salts, and combinations thereof, and
about 2 to about 20 weight percent of a filler; and
a sweetener
to form an encapsulated sweetener composition; wherein the encapsulating material at least partially encapsulates the sweetener and wherein all weight percents are based on the total weight of the encapsulated sweetener composition; and
melt blending a gum base and the encapsulated sweetener composition to form a chewing gum composition.

41-63. (canceled)

64. A method of preparing an encapsulated sweetener composition of claim 1 comprising:
melt blending
a poly(vinyl acetate),
about 2 to about 20 weight percent of a fatty acid salt selected from the group consisting of alkali metal fatty acid salts, alkaline earth metal fatty acid salts, and combinations thereof, and
about 2 to about 20 weight percent of a filler; and
a sweetener
to form an encapsulated sweetener composition; wherein the encapsulating material at least partially encapsulates the sweetener and wherein all weight percents are based on the total weight of the encapsulated sweetener composition.

65-81. (canceled)

82. The method of claim 64, wherein said melt blending the poly(vinyl acetate), the fatty acid salt, the filler, and the sweetener comprises melting the poly(vinyl acetate), blending the fatty acid salt with the melted poly(vinyl acetate), and blending the sweetener and the filler with the melt-blended poly(vinyl acetate) and fatty acid salt.

83. The method of claim 64, wherein said melt blending the poly(vinyl acetate), the fatty acid salt, the filler, and the sweetener comprises melt blending with a mixing energy of about 70 to about 350 kilojoules per kilogram of the encapsulated sweetener composition.

84. The method of claim 64,
wherein the fatty acid salt comprises magnesium stearate, calcium stearate, or combinations thereof;
wherein the filler comprises talc;
wherein the sweetener is selected from the group consisting of lo han guo, sucralose, monatin, rebaudioside A, steviosides, acesulfame potassium, aspartame, aspartame-acesulfame, and combinations thereof;
wherein the weight ratio of the fatty acid salt to the sweetener in the encapsulated sweetener composition is about 1:0.25 to about 1:25;
wherein the weight ratio of the fatty acid salt to the poly(vinyl acetate) in the encapsulated sweetener composition is about 1:1.75 to about 1:45;
wherein the weight ratio of the sweetener to the poly(vinyl acetate) in the encapsulated sweetener composition is about 1:0.7 to about 1:18; and
wherein the encapsulated sweetener composition has a number average particle size less than or equal to 420 micrometers.
